(19) United States
(12) Patent Application Publication
(10) Pub. No.: US 2024/0184228 A1
(43) Pub. Date: Jun. 6, 2024

(54) DEVELOPING CARTRIDGE

(71) Applicant: E-Z INK TECHNOLOGY CO., LTD, Zhuhai (CN)

(72) Inventors: Shengkui ZHAO, Zhuhai (CN); Dongming LIN, Zhuhai (CN); Peng WANG, Zhuhai (CN); Hangyu PENG, Zhuhai (CN)

(73) Assignee: E-Z INK TECHNOLOGY CO., LTD, Zhuhai (CN)

(21) Appl. No.: 18/436,075

(22) Filed: Feb. 8, 2024

Related U.S. Application Data
(63) Continuation-in-part of application No. PCT/CN2022/112560, filed on Aug. 15, 2022.

(30) Foreign Application Priority Data
Aug. 16, 2021 (CN) 202121918167.8
Sep. 10, 2021 (CN) 202122198354.X
Sep. 15, 2021 (CN) 202122242257.6
Oct. 10, 2021 (CN) 202122436825.6
Oct. 15, 2021 (CN) 202122495621.X
Nov. 29, 2021 (CN) 202122959967.0
Nov. 30, 2021 (CN) 202122985395.3
Jan. 10, 2022 (CN) 202220052453.9
Jun. 15, 2022 (CN) 202221500398.1

(51) Int. Cl. G03G 15/08

(52) U.S. Cl. CPC G03G 15/0863; G03G 15/0875; G03G 15/0889; G03G 2215/0695; G03G 2215/0852

(57) ABSTRACT

A developing cartridge includes a housing, a chip, and a chip connection assembly. The chip is provided with an electrical contact, and at least a part of the chip connection assembly may move relative to the housing as a movable member between a first position and a second position. In the first position, a communication connection cannot be established between the electrical contact and a power terminal outside the developing cartridge. In the second position, the movable member enables a communication connection to be established between the electrical contact and the power terminal outside the developing cartridge. Such a design can prevent damage to the electrical contact of the chip and improve working stability of the chip.

### CROSS REFERENCE TO THE RELATED APPLICATIONS

This application is the continuation-in-part application of International Application No. PCT/CN2022/112560, filed on Aug. 15, 2022, which is based upon and claims priority to Chinese Patent Applications No. 202121918167.8, filed on Aug. 16, 2021; No. 202122198354.X, filed on Sep. 10, 2021; No. 202122242257.6, filed on Sep. 15, 2021; No. 202122436825.6, filed on Oct. 10, 2021; No. 202122495621.X, filed on Oct. 15, 2021; No. 202122959967.0, filed on Nov. 29, 2021; No. 202122985395.3, filed on Nov. 30, 2021; No. 202220052453.9, filed on Jan. 10, 2022; and No. 202221500398.1, filed on Jun. 15, 2022; the entire contents of which are incorporated herein by reference.

### TECHNICAL FIELD

The present invention relates to the field of electrophotographic imaging, and in particular, to a developing cartridge detachably mounted in an electrophotographic imaging device.

### BACKGROUND

For an existing processing cartridge including a developing cartridge and a drum holder, before use, the developing cartridge needs to be mounted to the drum holder, and then the combination of the developing cartridge and the drum holder is mounted to an electrophotographic imaging device (hereinafter referred to as “device”). The developing cartridge includes toner and developing components such as a developing member and a doctor blade, which are required for development. Components such as a photosensitive drum and a charging member are disposed on the drum holder. When the processing cartridge works in the device, an electrostatic latent image is formed on a surface of the photosensitive drum, and the developing member is configured to supply the toner to the photosensitive drum and simultaneously develop the electrostatic latent image.

Generally, the service life of the photosensitive drum is designed to be far greater than the service life of the developing cartridge, to be specific, after the toner in the developing cartridge is consumed, an end user only needs to replace the developing cartridge, and the drum holder is kept for continuous use, thereby reducing use costs. In practice, a communication connection needs to be established between the developing cartridge and the device, so that the device can keep abreast of the use of the developing cartridge. Therefore, a chip is mounted in the developing cartridge, and the drum holder is provided with an exposure opening for exposing the chip. When the developing cartridge is mounted to the drum holder, the chip is exposed through the exposure opening.

### SUMMARY

The present invention provides a developing cartridge. The following technical solution is used to improve working stability of a chip. A specific solution is:

A developing cartridge is detachably mounted in a device, and the developing cartridge includes a housing, a chip, a developing member rotatably mounted in the housing, and a driving force receiving member located at a longitudinal end of the housing; the driving force receiving member is configured to receive a driving force from the outside of the developing cartridge to drive the developing member to rotate; the chip is provided with an electrical contact; the developing cartridge further includes a chip connection assembly, and at least a part of the chip connection assembly may move relative to the housing as a movable member between a first position and a second position; before the developing cartridge is mounted to the device, the movable member is in the first position, and in this case, an electrical connection between the electrical contact and the device is broken, and then a communication connection cannot be established between the electrical contact and the device; and as the developing cartridge is mounted to the device, the movable member moves from the first position to the second position, and in the second position, the movable member enables an electrical connection between the electrical contact and the device to be implemented, to establish a communication connection between the electrical contact and the device.

As described above, in the developing cartridge in the present invention, the electrical contact has the first position that cannot be electrically connected to a power terminal in an imaging device and the second position that can be electrically connected to the power terminal in the imaging device. Only in a mounting process of the developing cartridge, the electrical contact moves from the first position to the second position. After the developing cartridge is mounted, the electrical contact is electrically connected to the imaging device. Therefore, regardless of whether the developing cartridge is in a transportation process, in the mounting process, or in a process in which the developing cartridge is temporarily placed outside the imaging device, the electrical contact of the chip is not damaged by an external component.

### BRIEF DESCRIPTION OF THE DRAWINGS

FIG. 1 is a three-dimensional diagram of a developing cartridge and a drum holder in a processing cartridge after the developing cartridge and the drum holder are separated according to Embodiment 1 of the present invention;

FIG. 2A, FIG. 2B, and FIG. 3 are three-dimensional diagrams of the developing cartridge according to Embodiment 1 of the present invention;

FIG. 4 is a schematic exploded view of some components of the developing cartridge according to Embodiment 1 of the present invention;

FIG. 5 is a schematic diagram of a state after a stirring member and a drive rod in the developing cartridge are combined according to Embodiment 1 of the present invention;

FIG. 6A is a schematic diagram of a state in which the stirring member is in a third position and is viewed after the developing cartridge is cut along an AA direction in FIG. 3 according to Embodiment 1 of the present invention;

FIG. 6B is a schematic diagram of a state in which the stirring member is in a fourth position and is viewed after the developing cartridge is cut along the AA direction in FIG. 3 according to Embodiment 1 of the present invention;

FIG. 7A is a schematic diagram of a right side structure of the inside of a bottom housing of the developing cartridge according to Embodiment 1 of the present invention;

FIG. 7B is a schematic diagram of a left side structure of the inside of the bottom housing of the developing cartridge according to Embodiment 1 of the present invention;

FIG. 7C is a schematic diagram of a structure of the outside of the bottom housing of the developing cartridge according to Embodiment 1 of the present invention;

FIG. 8 is a schematic diagram of a relative position of a contact of a chip in the developing cartridge when the developing cartridge is viewed in a direction parallel to a left-right direction according to Embodiment 1 of the present invention;

FIG. 9 is a three-dimensional diagram of a stirring member, a drive rod, and a bottom housing in a developing cartridge according to Embodiment 2 of the present invention;

FIG. 10 is a three-dimensional diagram of a first end cover and a housing of a developing cartridge after the first end cover and the housing are separated according to Embodiment 3 of the present invention;

FIG. 11A is a three-dimensional diagram of a second driving member according to Embodiment 4 of the present invention;

FIG. 11B and FIG. 11C are three-dimensional diagrams of a driving end of the second driving member according to Embodiment 4 of the present invention;

FIG. 11D is a side view of a rotation axis of the second driving member when the rotation axis is viewed from the driving end according to Embodiment 4 of the present invention;

FIG. 12 is a three-dimensional diagram of a stirring member according to Embodiment 4 of the present invention;

FIG. 13 is a diagram of a state after the stirring member and a housing are separated according to Embodiment 4 of the present invention;

FIG. 14 is a diagram of a state after the stirring member is mounted to the housing according to Embodiment 4 of the present invention;

FIG. 15 is a schematic exploded view of some components on a counting side of a developing cartridge according to Embodiment 5 of the present invention;

FIG. 16 is a three-dimensional diagram showing that a toggle portion of a counting assembly is mounted to an end cover according to Embodiment 5 of the present invention;

FIG. 17 is a schematic exploded view of components of another conductive member according to Embodiment 5 of the present invention;

FIG. 18 is a side view of the developing cartridge viewed from bottom to top in an up-down direction of the developing cartridge according to Embodiment 5 of the present invention;

FIG. 19A is a schematic diagram of a position relationship between a plane in which a projection, on a chip connection assembly, of a contact point between the chip connection assembly and a power terminal is located and a rotation axis of a developing member in an existing developing cartridge;

FIG. 19B is a schematic diagram of a position relationship between a plane in which a projection, on a conductive member, of a contact point between the conductive member and a power supply member is located and the rotation axis of the developing member in the existing developing cartridge;

FIG. 20 is a schematic diagram of a position relationship between a plane in which a projection, on a conductive member, of a contact point between the conductive member and a power supply member is located and a rotation axis of a developing member and a position relationship between the plane and a plane in which a projection, on a chip connection assembly, of a contact point between the chip connection assembly and a power terminal is located in a developing cartridge according to Embodiment 6 of the present invention;

FIG. 21 is a schematic diagram of a position relationship between a plane in which a projection, on a conductive member, of a contact point between the conductive member and a power supply member is located and a rotation axis of a developing member in a developing cartridge according to Embodiment 7 of the present invention;

FIG. 22 is a schematic diagram of a position relationship between a plane in which a projection, on a conductive member, of a contact point between the conductive member and a power supply member is located and a rotation axis of a developing member in a developing cartridge according to Embodiment 8 of the present invention;

FIG. 23 is a schematic diagram of a position relationship between a plane in which a projection, on a conductive member, of a contact point between the conductive member and a power supply member is located and a rotation axis of a developing member in a developing cartridge according to Embodiment 9 of the present invention;

FIG. 24 is a schematic diagram of a position relationship between a plane in which a projection, on a chip connection assembly, of a contact point between the chip connection assembly and a power terminal is located and a rotation axis of a developing member in a developing cartridge according to Embodiment 10 of the present invention;

FIG. 25 is a schematic diagram of a position relationship between a plane in which a projection, on a chip connection assembly, of a contact point between the chip connection assembly and a power terminal is located and a rotation axis of a developing member and a position relationship between the plane and a plane in which a projection, on a conductive member, of a contact point between the conductive member and a power supply member is located in a developing cartridge according to Embodiment 11 of the present invention;

FIG. 26 is a schematic exploded view of a chip connection assembly in a developing cartridge according to Embodiment 12 of the present invention;

FIG. 27 is a side view of the developing cartridge when the developing cartridge is viewed from bottom to top in an up-down direction after a chip mounting assembly is hidden according to Embodiment 12 of the present invention;

FIG. 28 is a side view of viewing a position of the chip mounting assembly in the developing cartridge from left to right in a left-right direction before the developing cartridge is mounted to a drum holder according to Embodiment 12 of the present invention;

FIG. 29 is a comparison diagram of states of a conductive sheet in the chip connection assembly before and after the developing cartridge is mounted according to Embodiment 12 of the present invention;

FIG. 30 is a side view of viewing a position of a chip mounting assembly in a developing cartridge from left to right in a left-right direction before the developing cartridge is mounted to a drum holder according to Embodiment 13 of the present invention;

FIG. 31 is a three-dimensional diagram of a developing cartridge when the developing cartridge is viewed from a driving end according to Embodiment 16 of the present invention;

FIG. 32 is a schematic exploded view of a chip connection assembly in the developing cartridge according to Embodiment 16 of the present invention;

FIG. 33 is a three-dimensional diagram of an inner side of a first end cover according to Embodiment 16 of the present invention;

FIG. 34 is a side view of the developing cartridge when the developing cartridge is viewed from left to right in a left-right direction after the first end cover is hidden according to Embodiment 16 of the present invention;

FIG. 35 is a schematic diagram of a relative position between a conductor and a movable member when the movable member is in a first position in the developing cartridge according to Embodiment 16 of the present invention;

FIG. 36 is a three-dimensional diagram of a developing cartridge according to Embodiment 17 of the present invention;

FIG. 37 is a schematic exploded view of some components of a chip connection assembly in the developing cartridge according to Embodiment 17 of the present invention;

FIG. 38 is a three-dimensional diagram of a movable member in the chip connection assembly according to Embodiment 17 of the present invention;

FIG. 39A is a side view of breaking, by the chip connection assembly, an electrical connection between a chip and a device when the developing cartridge is viewed from left to right before mounting according to Embodiment 17 of the present invention;

FIG. 39B is a side view of electrically connecting, by the chip connection assembly, the chip to the device when the developing cartridge is viewed from left to right before mounting according to Embodiment 17 of the present invention;

FIG. 40 is a schematic exploded view of some components of a chip connection assembly in a developing cartridge according to Embodiment 18 of the present invention;

FIG. 41A is a schematic exploded view of a chip connection assembly and a housing after the chip connection assembly and the housing are separated in a developing cartridge according to Embodiment 19 of the present invention;

FIG. 41B is a schematic exploded view of the housing and some components of an end at which no chip connection assembly is mounted in the developing cartridge according to Embodiment 19 of the present invention;

FIG. 42 is a three-dimensional diagram of the chip connection assembly after the chip connection assembly is mounted to the housing in the developing cartridge according to Embodiment 19 of the present invention;

FIG. 43A and FIG. 43B are three-dimensional diagrams of a first end cover in the developing cartridge according to Embodiment 19 of the present invention;

FIG. 44A is a schematic diagram of a state of the chip connection assembly before the chip connection assembly is triggered in the developing cartridge according to Embodiment 19 of the present invention;

FIG. 44B is a schematic diagram of a state of the chip connection assembly after the chip connection assembly is triggered in the developing cartridge according to Embodiment 19 of the present invention;

FIG. 45 is a schematic diagram of states of a chip connection assembly before and after the chip connection assembly is triggered in a developing cartridge according to Embodiment 20 of the present invention;

FIG. 46 is a schematic exploded view of a developing cartridge after two end covers are separated from a housing according to Embodiment 21 of the present invention;

FIG. 47 is a top view of the developing cartridge when the developing cartridge is viewed from top to bottom in an up-down direction according to Embodiment 21 of the present invention;

FIG. 48 is a three-dimensional schematic diagram of a developing cartridge according to Embodiment 22 of the present invention;

FIG. 49 is a three-dimensional schematic diagram of an auxiliary frame in the developing cartridge according to Embodiment 22 of the present invention;

FIG. 50 is a three-dimensional schematic diagram of a combination of a memory and an electrical contact of the memory in the developing cartridge according to Embodiment 22 of the present invention;

FIG. 51 is a schematic diagram of a memory protective cover in the developing cartridge according to Embodiment 22 of the present invention;

FIG. 52 is a schematic diagram of an electrical connection section when the developing cartridge is not completely mounted in a printer according to Embodiment 22 of the present invention; and

FIG. 53 is a schematic diagram of an electrical connection section when the developing cartridge is completely mounted in the printer according to Embodiment 22 of the present invention.

### DETAILED DESCRIPTION OF THE EMBODIMENTS

The following describes the embodiments of the present invention in detail with reference to the accompanying drawings.

### Embodiment 1

### Overall Structure of a Developing Cartridge

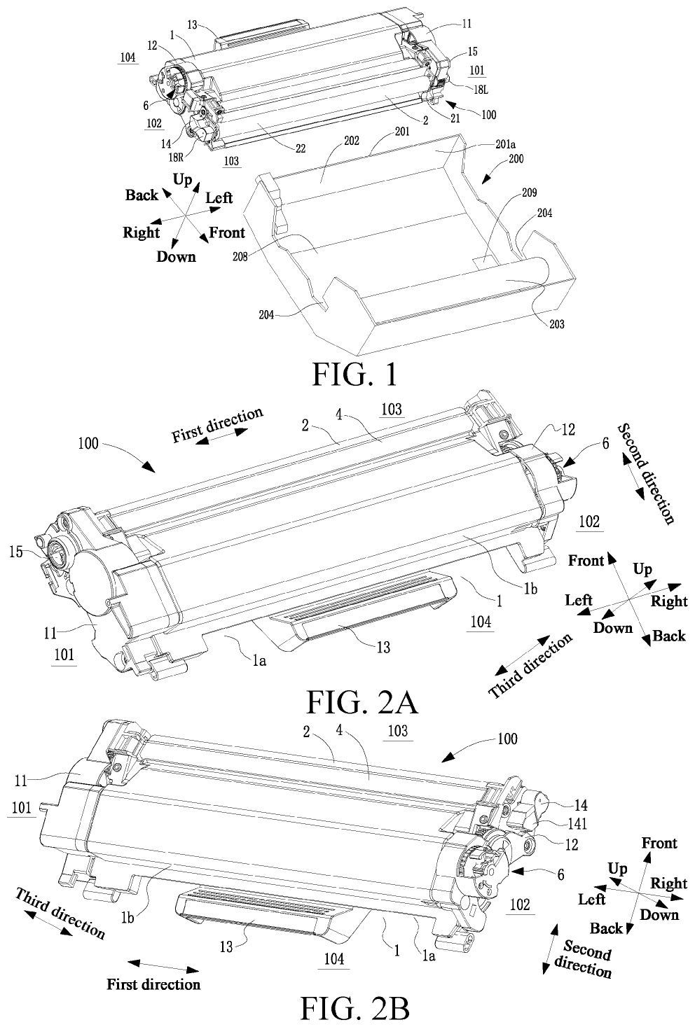

FIG. 1 is a three-dimensional diagram of a developing cartridge and a drum holder in a processing cartridge after the developing cartridge and the drum holder are separated according to Embodiment 1 of the present invention; and FIG. 2A, FIG. 2B, and FIG. 3 are three-dimensional diagrams of the developing cartridge according to Embodiment 1 of the present invention.

As shown in the figures, the developing cartridge 100 is overall rectangular in shape, an outer circumference of the developing cartridge 100 is an irregular surface, and the developing cartridge 100 is detachably mounted to a device. Based on a state in which the developing cartridge 100 is mounted to the device, the developing cartridge 100 has a left-right direction parallel to a length direction/longitudinal direction, a front-back direction parallel to a width direction/transverse direction, and an up-down direction parallel to a height direction/vertical direction. In the left-right direction, the front-back direction, and the up-down direction, the developing cartridge 100 extends a largest dimension in the left-right direction, and is mounted forward and dismounted backward in the front-back direction. For simplicity, the left-right direction is also referred to as a first direction, the front-back direction is also referred to as a second direction, and the up-down direction is also referred to as a third direction.

The developing cartridge 100 includes a housing 1/bin 350 and a developing member 2 and a stirring member 5 that are located in the housing 1. Toner is accommodated in the housing 1. The stirring member 5 is configured to stir the toner and convey the toner to the developing member 2. The developing member 2 extends in the first direction to supply the toner outward. For example, when the developing cartridge 100 is mounted to a drum holder 200 provided with a photosensitive drum, the developing member 2 is opposite to the photosensitive drum and supplies the toner to a surface of the photosensitive drum in a working process of the developing cartridge 100. When the photosensitive drum is located in the device, the developing cartridge 100 does not need to be mounted to the drum holder 200 first, but may be directly mounted to the device, and supplies the toner to the surface of the photosensitive drum. Therefore, the mounting of the developing cartridge 100 described below means that the developing cartridge 100 is mounted to the drum holder 200 or the developing cartridge 100 is mounted to the device. On the contrary, removal of the developing cartridge 100 means removal of the developing cartridge 100 from the drum holder 200 or removal of the developing cartridge 100 from the device. In addition, the developing cartridge 100 further includes a handle 13 disposed on the housing 1. The developing member 2 and the handle 13 are respectively located at two ends in the second direction. Specifically, the developing cartridge 100 has a front end 103 at the front side and a rear end 104 at the rear side. The developing member 2 is located at the front end 103 and the handle 13 is located at the rear end 104. A user may easily mount and dismount the developing cartridge 100 by grasping the handle 13.

To control the thickness of a toner layer on a surface of the developing member 2, the developing cartridge 100 further includes an adjustment member 4 contacting the developing member 2. In a rotation process of the developing member 2, the adjustment member 4 adjusts the toner on the surface of the developing member 2 to a predetermined thickness. Further, the developing cartridge 100 further includes end covers 380, a driving force receiving member 15, and a counting assembly 6 that are located at longitudinal ends of the housing. As shown in the figures, a first end cover 11 and a second end cover 12 are respectively located on a left side and a right side of the housing 1, and the driving force receiving member 15 and the counting assembly 6 may be located at a same end of the housing 1. In this case, the driving force receiving member 15 is exposed through the first end cover 11, and a part of the counting assembly 6 is also exposed from the first end cover 11. When the counting assembly 6 and the driving force receiving member 15 are disposed on different sides, the driving force receiving member 15 and the counting assembly 6 may be respectively located at the two ends of the housing 1. In this case, the driving force receiving member 15 is exposed through the first end cover 11, and a part of the counting assembly 6 is exposed from the second end cover 12.

When the developing cartridge 100 works, the driving force receiving member 15 receives a driving force from the device and rotates around a rotation axis L, the developing member 2 rotates around a rotation axis L5 and is configured to supply the toner outward, the counting assembly 6 is driven by the driving force from the driving force receiving member 15, and interacts with a detecting component 400 (as shown in FIG. 2B) in the device. A process in which the counting assembly 6 interacts with the detecting component 400 is referred to as a counting process, and in this process, information such as a model and a lifetime of the developing cartridge 100 is identified by the device.

In the following, that the driving force receiving member 15 and the counting assembly 6 are respectively located at the two ends of the housing 1 is used as an example for description. In this way, when the driving force receiving member 15 works, impact on the counting assembly 6 may be reduced. As shown in the figure, the driving force receiving member 15 is located on the left side of the housing 1, and the counting assembly 6 is located on the right side of the housing 1. Therefore, the side on which the driving force receiving member 15 is located may also be referred to as a driving end 101/first end 351, and the side on which the counting assembly 6 is located may also be referred to as a counting side 102. Certainly, the counting assembly 6 may alternatively be on a same side as the driving force receiving member 15. In this way, the counting assembly 6 may be directly combined with the driving force receiving member 15, so that the counting assembly 6 has a higher response speed of receiving the driving force.

The drum holder 200 includes a frame 201 enclosed to form a developing cartridge accommodating cavity 202 and a photosensitive drum 203 rotatably mounted in the frame 201. Fastening grooves 204 are disposed on two sidewalls of the frame 201 in the left-right direction, a baseplate 208 extends in the front-back direction, and an opening 209 is disposed on the baseplate 208 to allow exposure of an electrical contact located in the developing cartridge 100. The fastening grooves 204 are configured to be combined with a support portions 18L/18R located at an end of the developing cartridge 100 in the left-right direction, and allow the developing cartridge to rotate relative to the drum holder 200 by using the support portion 18L/18R as a fulcrum.

As shown in FIG. 2A and FIG. 2B, the housing 1 includes a bottom housing 1a and a top cover 1b that are combined in the up-down direction, and a cavity 10 for accommodating the toner is formed between the bottom housing 1a and the top cover 1b. The stirring member 5 is movably mounted in the cavity 10. In some embodiments, the stirring member 5 is a component formed integrally. Before the developing cartridge is assembled, another component does not need to be mounted for the stirring member 5, and the stirring member 5 is directly placed in the cavity 10. In addition, the stirring member 5 is disposed to reciprocate in a non-rotating manner in the front-back direction and/or the up-down direction. In a moving process of the stirring member 5, the toner at the rear end is conveyed to the front end, and a structure of a driving force output component between the driving force receiving member 15 and the stirring member 5 may be simplified because the stirring member 5 does not rotate.

The developing cartridge 100 further includes a toner conveying member 3 located in the housing 1 and a conductive member 14 located on the counting side 102. In the left-right direction, the toner conveying member 3 and the developing member 2 each have an end located at the driving end 101 and an end located on the counting side 102. When the developing cartridge 100 is mounted to the device, the conductive member 14 receives power from the power supply member in the device, and supplies the power to the developing member 2 and the toner conveying member 3. The conductive member 14 is at the same side as the counting assembly 6, so that the counting side 102 may also be referred to as a conductive side. As described above, the counting assembly 6 receives the driving force of the driving force receiving member 15 to work. Therefore, the developing cartridge 100 further includes a driving force transmitting assembly 8/driving assembly 370 for transmitting the driving force of the driving force receiving member 15. Through the driving force transmitting assembly 8/driving assembly 370, the developing member 2, the toner conveying member 3, the stirring member 5, and the counting assembly 6 are all driven.

### Driving Force Transmitting Assembly

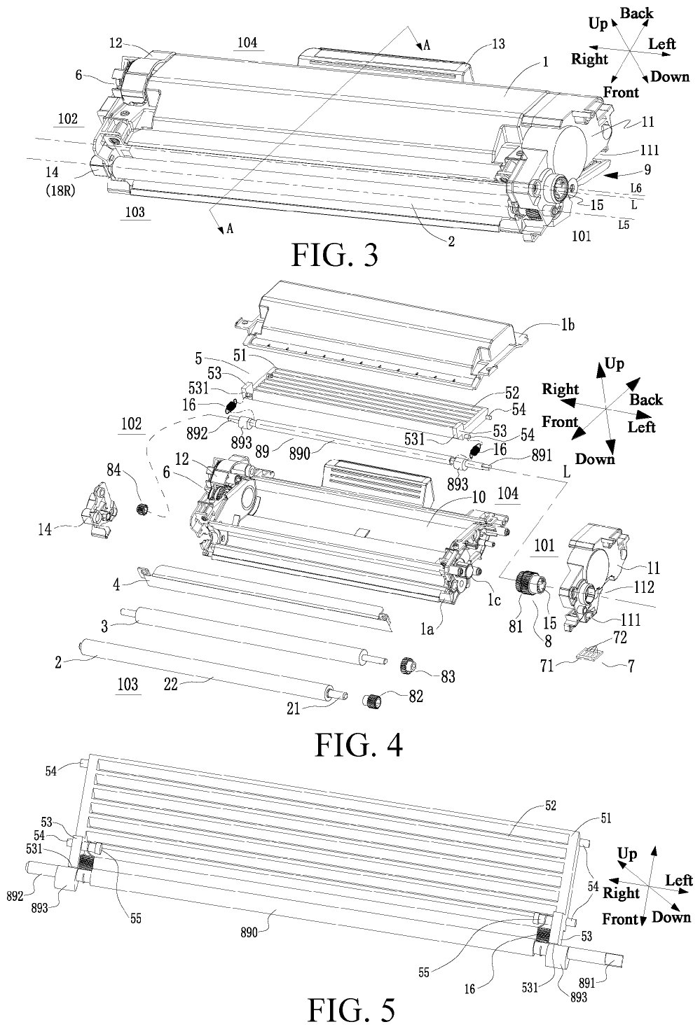

FIG. 4 is a schematic exploded view of some components of the developing cartridge according to Embodiment 1 of the present invention.

As shown in the figure, the driving force transmitting assembly 8 includes a first driving member 81 combined with the driving force receiving member 15, a developing member driving member 82 at an end of the developing member 2, a toner conveying member driving member 83 at an end of the toner conveying member 3, a middle member 84 on the same side as the counting assembly 6, and a second driving member 89 rotatably mounted in the housing 1. The second driving member 89 extends in the left-right direction/first direction, where the first driving member 81 and the driving force receiving member 15 are formed integrally, and are rotatably supported by a supporting protrusion 1c on the housing 1, and the second driving member 89 is configured to drive the stirring member 5 to move in the cavity 10. Preferably, the first driving member 81 is a gear, and correspondingly, the developing member driving member 82 and the toner conveying member driving member 83 each are a gear that can mesh with the first driving member 81, and the middle member 84 is a gear that is mounted on a counting side of the second driving member 89.

In the present invention, the first driving member 81 and the middle member 84 are respectively located at two ends of the second driving member 89, and the second driving member 89 is directly combined with the first driving member 81. In this way, the driving force received by the driving force receiving member 15 from the device may be directly transmitted to the second driving member 89 through the first driving member 81, and finally, the stirring member 5 is driven by the second driving member 89 to move, so that driving force transmission efficiency between the driving force receiving member 15 and the stirring member 5 can be effectively improved, and wear between the second driving member 89 and the first driving member 81 is reduced. Especially, when the driving force receiving member 15 is closer to the front end 103, a long gear group between the stirring member 5 and the driving force receiving member 15 may be omitted, and further, the appearance of the driving end 101 of the developing cartridge can be simplified.

The first end cover 11 is mounted at the driving end 101, the driving force receiving member 15 is exposed through a through hole 112 of the first end cover, the second end cover 12 is mounted on the counting side 102, the counting assembly 6 is exposed through a through hole of the second end cover, and both the first end cover 11 and the second end cover 12 cover a part of the driving force transmitting assembly 8. After the gear group between the stirring member 5 and the driving force receiving member 15 is omitted, in a mounting processing of the first end cover 11, it is not necessary to consider a problem of position correspondence between the first end cover 11 and the gear group, and in a dismounting process of the first end cover 11, it is also not necessary to consider a problem of falling of the gear group after the first end cover 11 is removed. Therefore, it can be seen that the mounting process and dismounting process of the first end cover 11 are simplified, thereby improving efficiency.

In this embodiment, the developing cartridge further includes an elastic member 16 located between the stirring member 5 and the second driving member 89, and the stirring member 5 implements reciprocating movement in the front-back direction/second direction and/or in the up-down direction/third direction under a joint action of the elastic member 16 and the second driving member 89. The second driving member 89 includes a middle rod 890, a first combining portion 891 and a second combining portion 892 that are respectively on the left side and the right side of the middle rod 890, where the first combining portion 891 is configured to be combined with the first driving member 81, and the second combining portion 892 is configured to be combined with the middle member 84. Therefore, the first driving member 81, the second driving member 89, and the middle member 84 rotate together around the rotation axis L. Further, the second driving member 89 further includes a force applying portion 893 that is configured to apply an acting force to the stirring member 5. The force applying portion 893 is disposed on the middle rod 890, but is eccentric relative to the middle rod 890, resulting in that force applying portion 893 and the middle rod 890 are not collinear. In addition, the force applying portion 893 has a force applying surface that is configured to apply an acting force and a non-force applying surface that does not apply an acting force. When the second driving member 89 rotates, the force applying surface gradually approaches the stirring member 5, and applies an acting force to the stirring member 5, so that elastic deformation occurs on the elastic member 16; and when the force applying surface gradually moves away from the stirring member 5 and the non-force applying surface gradually approaches the stirring member 5, the stirring member 5 is restored under an elastic restoring force of the elastic member 16.

Preferably, the force applying portion 893 is a cam disposed on the second driving member 89, and two cams 893 are respectively disposed on two ends of the second driving member 89 in the left-right direction/first direction, and the two cams 893 are opposite to the stirring member 5 in the front-back direction/second direction.

### Stirring Member

FIG. 5 is a schematic diagram of a state after the stirring member and a drive rod in the developing cartridge are combined according to Embodiment 1 of the present invention.

The elastic member 16 is preferably a tension spring, one end of which is connected to the stirring member 5, and the other end of which is connected to the second driving member 89. The stirring member 5 is formed integrally, and includes a frame 51, toner conveying plates 52 connected to the frame 51, and a force receiving portion 53. A plurality of toner conveying plates 52 are disposed, and each toner conveying plate extends in the left-right direction/first direction, and has a specific size in both the front-back direction/second direction and the up-down direction/third direction. The plurality of toner conveying plates 52 are arranged at intervals in the front-back direction/second direction. When the stirring member 5 moves forward, the toner is conveyed forward by the toner conveying plates 52. The force receiving portion 53 is formed by protruding forward from the frame 51, has a force receiving surface 531 on the front side, and is configured to cooperate with the cam 893 and receive a driving force of the cam 893.

As shown in FIG. 5, the stirring member 5 further includes guide protrusions 54 protruding from outer sides of the frame 51 to the left side and the right side, and a combination protrusion 55 protruding from an inner side of the force receiving portion 53 or an inner side of the frame 51 to the left side or the right side, and one end of the tension spring 16 is combined with the combination protrusion 55. When the stirring member 5 reciprocates in the cavity 10, the guide protrusions 54 guide the stirring member 5, to ensure a stable moving track of the stirring member 5.

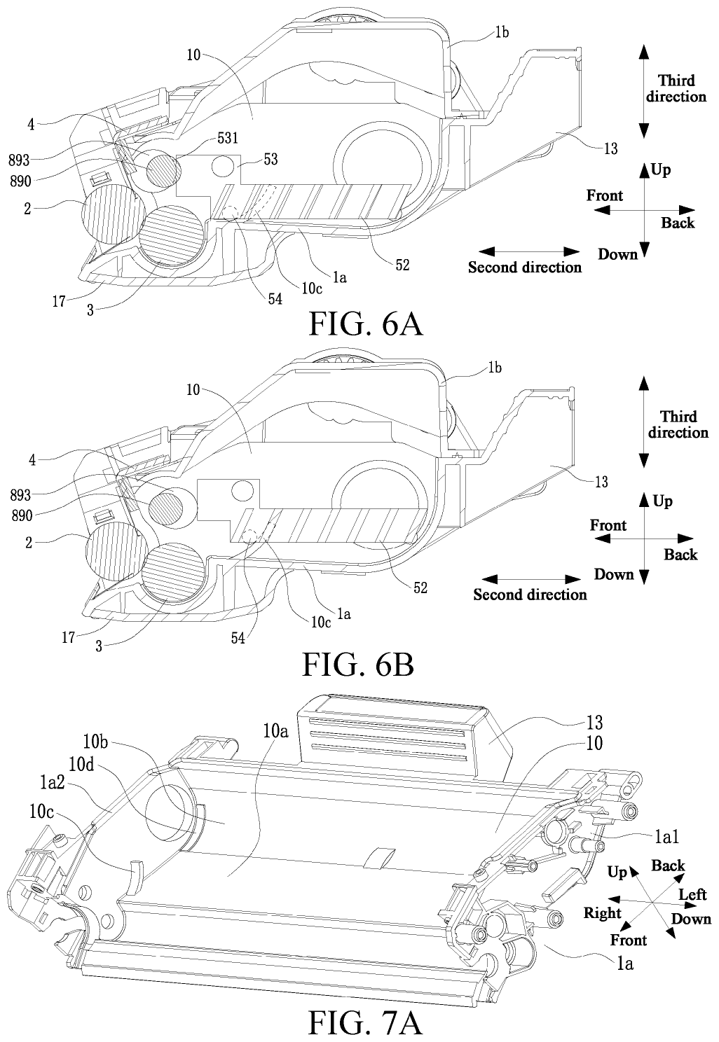

FIG. 6A is a schematic diagram of a state in which the stirring member is in a third position and is viewed after the developing cartridge is cut along an AA direction in FIG. 3 according to Embodiment 1 of the present invention; and FIG. 6B is a schematic diagram of a state in which the stirring member is in a fourth position and is viewed after the developing cartridge is cut along the AA direction in FIG. 3 according to Embodiment 1 of the present invention.

As shown in the figures, the toner conveying plate 52 is an inclined plate. Therefore, the toner conveying plate 52 is neither parallel to the up-down direction/third direction, nor perpendicular to the front-back direction/second direction. Specifically, the toner conveying plate 52 is inclined from the upper back to the lower front, and may be described as: along the front-back direction/second direction, the lower end, located in the up-down direction/third direction, of the toner conveying plate 52 is closer to the developing member 2/second driving member 89 than the upper end located in the up-down direction/third direction.

As shown in FIG. 6A, when the non-force applying surface of the force applying portion 893 presses against the force receiving surface 531, the stirring member 5 is not subjected to a force and is held in the third position close to the developing member 2. With rotation of the second driving member 89, the force applying surface gradually presses against the force receiving surface 531, to drive the stirring member 5 to gradually move backward. As shown in FIG. 6B, when the highest point of the force applying surface is opposite to the force receiving surface 531, the stirring member 5 reaches the fourth position away from the developing member 2, and the tension spring 16 deforms elastically. When the force applying surface gradually detaches from the force receiving surface 531, the stirring member 5 moves from the fourth position to the third position under a tensile force of the tension spring 16, and this process is repeated, so that the stirring member 5 reciprocates in the front-back direction/second direction and the up-down direction/third direction.

Apparently, the stirring member 5 is no longer rotated around an axis, but performs combined translation in the front-back direction/second direction and the up-down direction/third direction. A driving force of the stirring member 5 is generated by rotation of the second driving member 89. Compared with the stirring member 5, the second driving member 89 is closer to the developing member 2, and the second driving member 89 is directly combined with the first driving member 81 in a manner in which the second driving member 89 and the first driving member 81 are collinear. Therefore, a complex gear group does not need to be disposed between the first driving member 81/driving force receiving member 15 and the stirring member 5, to transmit the driving force. The second driving member 89 and the first driving member 81 may further be directly combined in a manner other than the manner in which the second driving member 89 and the first driving member 81 are collinear, and the two may also be combined by using a slider, a universal joint, or the like, so that the driving force of the first driving member 81 is also rapidly and efficiently transmitted to the second driving member 89. Especially, when space inside a cavity 10 is sufficient, the second driving member 89 and the first driving member 81 are combined by using the slider, the universal joint, or the like, a movement range of the second driving member 89 is larger, and correspondingly, a movement range of the stirring member 5 becomes larger.

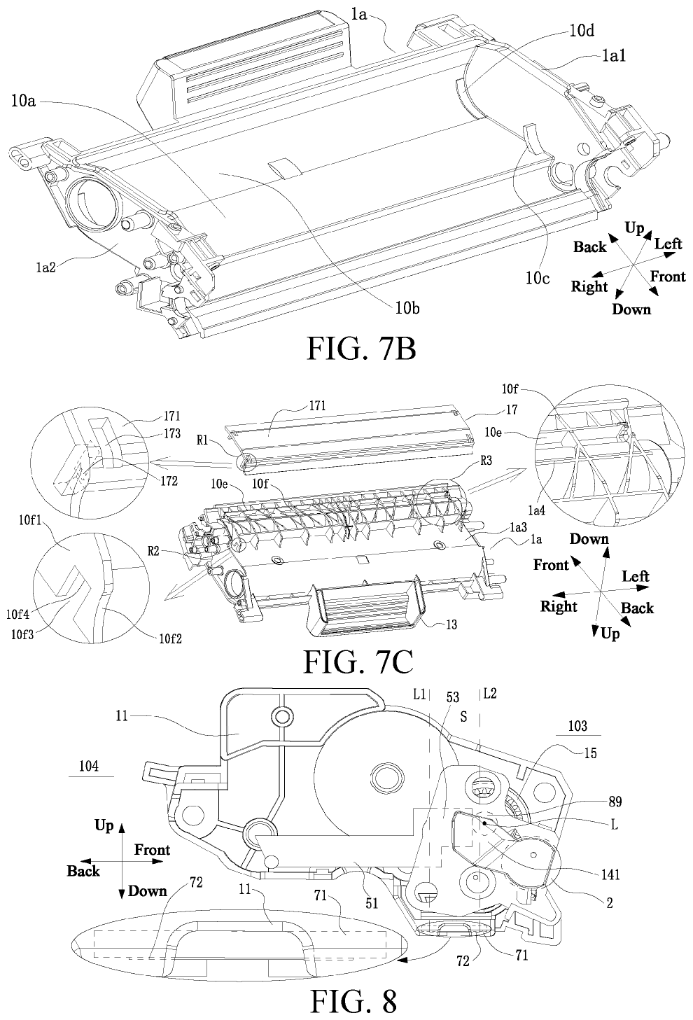

FIG. 7A is a schematic diagram of a right side structure of the inside of the bottom housing of the developing cartridge according to Embodiment 1 of the present invention; FIG. 7B is a schematic diagram of a left side structure of the inside of the bottom housing of the developing cartridge according to Embodiment 1 of the present invention; and FIG. 7C is a schematic diagram of a structure of the outside of the bottom housing of the developing cartridge according to Embodiment 1 of the present invention.

As shown in FIG. 7A, the bottom housing 1a includes a bottom side plate 10a that is located on the lower side, a rear side plate 10b that is located on the rear side, a left side plate 1a1 that is located on the left side, and a right side plate 1a2 that is located on the right side. The bottom side plate 10a, the rear side plate 10b, the left side plate 1a1, and the right side plate 1a2 are enclosed together to form a part of the cavity 10. Both the bottom side plate 10a and the rear side plate 10b are non-planar, to more precisely guide the stirring member 5. The developing cartridge 100 further includes at least one guide track protruding into the cavity 10 from at least one the left side plate 1a1 and the right side plate 1a2. Preferably, a guide track protrudes into the cavity 10 from both the left side plate 1a1 and the right side plate 1a2, and the guide tracks are symmetrical in the left-right direction/first direction. Correspondingly, a guide protrusion 54 matching the guide track is disposed on the outer side of the frame 51 of the stirring member 5.

FIG. 7A or FIG. 7B is used as an example. The guide track is at least one of a first guide track 10c and a second guide track 10d. The guide protrusion 54 of the stirring member 5 is combined with the guide track. In a movement process of the stirring member 5, the guide protrusion 54 is guided by the guide track. Preferably, both the first guide track 10c and the second guide track 10d are disposed, the first guide track 10c extends from the bottom side plate 10a to the inside of the cavity 10, the second guide track 10d protrudes from the rear side plate 10b to the inside of the cavity 10, and both the first guide track 10c and the second guide track 10d are disposed in an arc shape with a small radian, so that the stirring member 5 can move more smoothly while the strength of the guide tracks is enhanced. More preferably, the first guide track 10c is further connected to the left side plate 1a1 or the right side plate 1a2, to further enhance the strength of the first guide track 10c.

It should be noted that, in this embodiment, although the first guide track 10c and the second guide track 10d are disposed in an arc shape, because the radians of the first guide track 10c and the second guide track 10d are small, when the guide protrusion 54 is guided, an entire movement process of the stirring member 5 may still be considered as translation in the front-back direction/second direction and the up-down direction/third direction. It may be understood that the first guide track 10c and the second guide track 10d may be further disposed in a planar shape. For example, the first guide track 10c and the second guide track 10d are disposed as planar tracks extending in the front-back direction/second direction, and in this case, the stirring member 5 translates in the front-back direction/second direction. Alternatively, the first guide track 10c and the second guide track 10d are disposed as planar tracks extending in the up-down direction/third direction, and in this case, the force applying portion 893 and the force receiving portion 53 of the stirring member 5 are not disposed in the front-back direction/second direction but are disposed in the up-down direction/third direction. With rotation of the second driving member 89, the stirring member 5 translates in the up-down direction/third direction, or, as described above, the stirring member 5 moves in both the front-down direction/second direction and the up-down direction/third direction.

As shown in FIG. 6A, FIG. 6B, and FIG. 7C, the developing cartridge 100 further includes a protective plate 17 that is combined with the bottom housing 1a. First, as shown in FIG. 7C, the bottom side plate 10a of the bottom housing 1a has a lower surface 1a3 facing downward, a plurality of longitudinal ribs 10e and a plurality of transverse ribs 10f are formed by protruding downward from the lower surface 1a3, the plurality of longitudinal ribs 10c all extend in the left-right direction/first direction, and the plurality of transverse ribs 10f all extend in the front-back direction/second direction. The plurality of longitudinal ribs 10c are arranged at intervals in the front-back direction/second direction, and the plurality of transverse ribs 10f are also arranged at intervals in the left-right direction/first direction. Therefore, each longitudinal rib 10e intersects with the plurality of transverse ribs 10f, so that the plurality of crosswise-disposed ribs are conducive to improving strength of the bottom housing 1a, thereby preventing deformation of the bottom housing 1a and further avoiding toner leakage or an imaging defect.

In the up-down direction/third direction, the ribs further protrude downward from the lower surface 1a3. To prevent the ribs from being broken, in this embodiment, preferably, in the up-down direction/third direction, parts of the ribs extending downward do not go beyond the lowest point/line 1a4 of the lower surface 1a3. As shown in the part R3 in FIG. 7C, both the longitudinal ribs 10e and the transverse ribs 10f are flush with the lowest point/line 1a4 of the lower surface 1a3.

To further prevent the ribs from being broken, the protective plate 17 is mounted on the bottom housing 1a, and a manner combining the protective plate 17 with the bottom housing 1a is not limited. To be specific, the protective plate 17 may be integrally molded with the bottom housing 1a, or may be combined with the bottom housing 1a in a detachable manner. In terms of implementation of a mold, the protective plate 17 and the bottom housing 1a are formed separately. Specifically, the protective plate 17 is snap-fastened to the bottom housing 1a, so that the protective plate 17 can be easily mounted and dismounted.

As shown in FIG. 7C, the protective plate 17 includes a cover plate 171 and a clamping protrusion 172 (as shown in the part R1) disposed on the cover plate 171. As shown in the part R2, one of the transverse ribs 10f includes a main rib 10f1 and a positioning rib 10f2 between which a gap 10f3 is formed in the front-back direction/second direction, a clamping surface 10f4 is formed on a side that is of the main rib 10f1 and the positioning rib 10f2 and that faces the lower surface 1a3, and the clamping protrusion 172 is clamped to the clamping surface 10f4 to complete combination of the protective plate 17 and the bottom housing 1a. Further, on the protective plate 17, a limiting portion 173 is disposed adjacent to the clamping protrusion 172. When the protective plate 17 is mounted to the bottom housing 1a, the limiting portion 173 is combined with the positioning rib 10f2, to ensure that the protective plate 17 can be more stably combined with the bottom housing 1a. Preferably, the limiting portion 173 is a through hole or a blind hole, provided that the limiting portion 173 can be combined with the positioning rib 10f2.

### Relative Position of the Chip in the Developing Cartridge

FIG. 8 is a schematic diagram of a relative position of the electrical contact of the chip in the developing cartridge when the developing cartridge is viewed in a direction parallel to the left-right direction according to Embodiment 1 of the present invention.

With reference to FIG. 4 and FIG. 8, the developing cartridge 100 further includes the chip 7/memory 310 mounted in the developing cartridge 100. When the developing cartridge 100 is mounted to the device, the chip 7 establishes a communication connection to the device. In this embodiment, the chip 7 is mounted on a chip mounting portion 111/holder 320 of the first end cover 11. The chip 7 includes a substrate 71, and an electrical contact (72, 311) and a storage portion 73 (as shown in FIG. 52) that are respectively located on two sides of the substrate 71, and the electrical contact 72 faces in a lower direction/third direction and is electrically connected to the device.

In this embodiment, the electrical contact 72 of the chip 7 and the conductive member 14 are respectively located at two longitudinal ends of the housing 1. Specifically, the electrical contact 72 of the chip 7 is located on the left side of the housing 1, and the conductive member 14 is located on the right side of the housing 1. Correspondingly, components in the device that are electrically connected to the electrical contact 72 and the conductive member 14 respectively are also distributed at the two longitudinal ends of the housing 1. In this way, a terminal (an electrical interface 141 of the conductive member 14) through which the developing cartridge 100 receives power from the device and a terminal (the electrical contact 72 of the chip 7) through which the developing cartridge 100 establishes a communication connection to the device are as far apart as possible in space, and electromagnetic interference between the two terminals may be minimized. In particular, for the electrical contact 72 of the chip 7, when the developing cartridge 100 works, data needs to be transmitted between the electrical contact 72 and the device, so that it is necessary to consider reducing external electromagnetic interference.

To make the following description clearer, the housing 1 is hidden in FIG. 8 and viewing is performed from right to left in the left-right direction. In this way, the conductive member 14 is not shielded by the first end cover 11. As shown in the figure, a straight line L1 and a straight line L2 that are parallel to the up-down direction are respectively drawn from the two ends of the electrical contact 72 in the up-down direction/third direction, and an area S is defined between the two straight lines in the front-back direction/second direction. In the front-back direction/second direction, at least a part of the electrical interface 141 is located in the area S, that is, in the up-down direction/third direction, at least a part of the electrical interface 141 overlaps with a projection of the electrical contact 72 in the up-down direction/third direction. In this way, a circuit routing in the front-back direction/second direction in the device may be simplified, which is conductive to reducing a size of the device in the front-back direction/second direction.

When the second driving member 89 and the driving force receiving member 15 have a common axis L, the axis L is located outside the area S, that is, in the up-down direction/third direction, the rotation axis L of the driving force receiving member 15 and the second driving member 89 is not opposite to the electrical contact 72, or the projection of the electrical contact 72 in the up-down direction/third direction does not overlap with the rotation axis L. Specifically, the rotation axis L is located on the front side of the area S, and the developing member 2 is also located on the front side of the area S. In this way, when the electrical contact 72 of the chip and the driving force receiving member 15 are located on the same side (the driving end 101) of the housing 1, impact of vibration generated by the driving force receiving member 15 during rotation on the electrical contact 72 of the chip is reduced, and impact of vibration generated by the developing member 2 during rotation on the electrical contact 72 of the chip is also reduced, thereby improving stability of the electrical contact 72 of the chip.

In the present invention, a part of the stirring member 5 is located in the area S, that is, in the up-down direction/third direction, a part of the stirring member 5 overlaps with the electrical contact 72. Specifically, at least a part of the force receiving portion 53 is located in the area S. In this way, the force receiving portion 53 may be closer to the rotation axis L of the second driving member 89, and the driving force of the second driving member 89 may be transmitted to the force receiving portion 53 more efficiently. In particular, for a new developing cartridge 100, there is a large amount of toner in the cavity 10, and the stirring member 5 needs a large acting force to move. As the toner in the cavity 10 is consumed, the developing cartridge 100 presents a phenomenon that the front end 103 is heavier than the rear end 104 in the front-back direction/second direction. However, disposing at least a part of the force receiving portion 53 in the area S can ensure that the center of gravity of the frame 51 of the stirring member 5 is outside the area S. Specifically, the center of gravity is located on the rear side of the area S. In this way, the weight of the stirring member 5 can balance a part of the weight of the front end, and working stability of the developing cartridge 100 is improved.

In a modification of this embodiment, the electrical contact 72 of the chip 7 may be separated from the substrate 71. In this case, the substrate 71 and the electrical contact 72 may be connected by using a wire. When a relative position of the electrical contact 72 in the developing cartridge 100 is determined, the substrate 71 and the storage portion 73 may be placed in other positions according to a structural design requirement of the developing cartridge 100.

### Embodiment 2

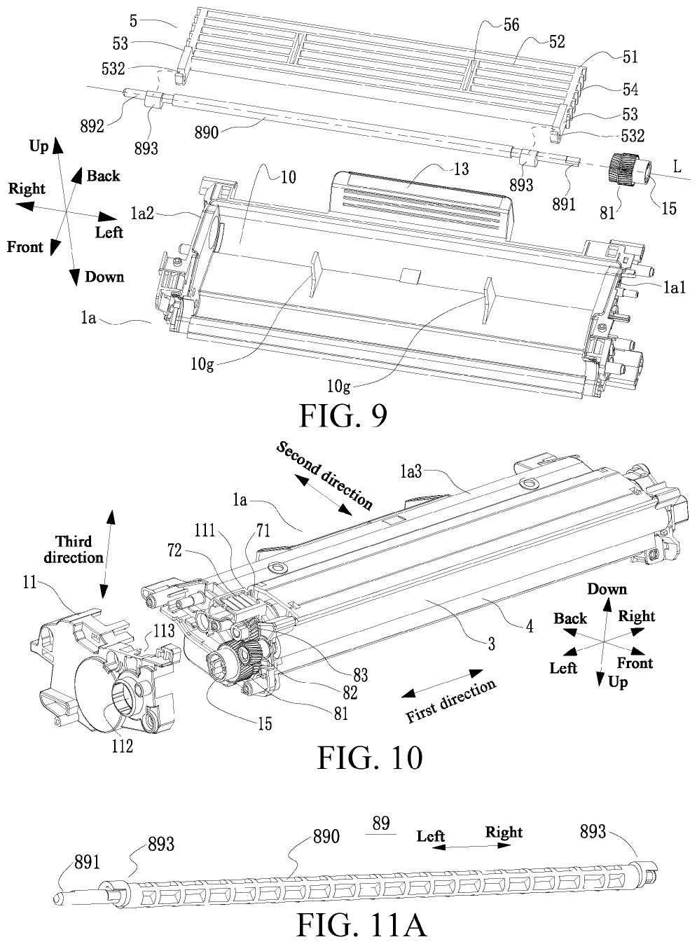

FIG. 9 is a three-dimensional diagram of a stirring member, a drive rod, and a bottom housing in a developing cartridge according to Embodiment 2 of the present invention.

A difference between this embodiment and Embodiment 1 lies in a manner of combining the stirring member 5 with the second driving member 89, components that are the same as those in Embodiment 1 are not described in detail, and same numbers are used in the following.

As shown in FIG. 9, the stirring member 5 includes a combination groove 532 disposed in the force receiving portion 53, and the force applying portion 893 is accommodated in the combination groove 532. In this case, the stirring member 5 is combined with the second driving member 89 in a loose fit manner, and the stirring member 5 may reciprocate in the cavity 10 with rotation of the second driving member 89. In addition, the second driving member 89 and the first driving member 81/driving force receiving member 15 have a common rotation axis L. When the force applying surface of the force applying portion 893 presses forward against a side wall of the combination groove 532, the entire stirring member 5 is pushed to move forward; and when the force applying surface of the force applying portion 893 presses backward against a side wall of the combination groove 532, the entire stirring member 5 is pushed to move backward.

An elastic member no longer needs to be disposed between the stirring member 5 and the second driving member 89 in this embodiment, and a quantity of parts of the developing cartridge 100 is reduced. More directly, driving force transmission between the second driving member 89 and the stirring member 5 is more direct, and force transmission efficiency is higher. To ensure that the moving track of the stirring member 5 is stable, similarly, a plurality of guide protrusions 54 are disposed outside the frame 51 of the stirring member 5 in this embodiment. In a movement process of the stirring member 5, the guide protrusions 54 contact inner surfaces of the left side plate 1a1 and the right side plate 1a2. Further, a guide groove 56 is disposed on the stirring member 5. Correspondingly, a guide block 10g that is combined with the guide groove 56 is disposed on the bottom housing 1a, and preferably, the guide groove 56 extends in the front-back direction. Therefore, the moving track of the stirring member 5 is effectively determined.

### Embodiment 3

FIG. 10 is a three-dimensional diagram of a first end cover and a housing of a developing cartridge after the first end cover and the housing are separated according to Embodiment 3 of the present invention.

A difference between this embodiment and the foregoing embodiments lies in a position of the chip mounting portion 111. The chip mounting portion 111 in this embodiment is no longer disposed on the first end cover 11, but is disposed on the housing 1. As shown in the figure, the chip mounting portion 111 is on a same side as the lower surface 1a3 of the bottom housing, the chip mounting portion 111 protrudes from the bottom housing 1a to the left on the whole, and correspondingly, a concave portion 113 that matches the chip mounting portion 111 is disposed on the first end cover 11.

As described above, a gear group for transmitting a driving force no longer needs to be disposed between the stirring member 5 and the driving force receiving member 15, which is embodied outside the housing 1, that is, a gear group does not need to be disposed on the rear side of the driving force receiving member 15 for simplification. When the first end cover 11 is combined with the bottom housing 1a, the driving force receiving member 15 passes through the through hole 112 of the first end cover. In this case, the driving force receiving member 15 may be considered as a first positioning protrusion, and the through hole 112 may be considered as a first positioning hole.

However, to enable the first end cover 11 to be smoothly combined with the bottom housing 1a, at least another positioning protrusion and another positioning hole are required between the first end cover and the bottom housing. In this embodiment, when the chip mounting portion 111 is disposed on the bottom housing 1a, and the concave portion 113 is disposed on the first end cover 11, the chip mounting portion 111 may be considered as a second positioning protrusion, and the concave portion 113 may be considered as a second positioning hole. In this way, the first positioning protrusion 15 is combined with the first positioning hole 112, and the second positioning protrusion 111 is combined with the second positioning hole 113, so that the first end cover 11 and the bottom housing 1a may be smoothly combined.

Although a person skilled in the art may additionally dispose a protrusion on the bottom housing 1a, to additionally dispose a concave portion that is combined with the protrusion on the first end cover 11. Compared with sizes of the driving force receiving member 15 and the through hole 112 and sizes of the chip mounting portion 111 and the concave portion 113, sizes of the protrusion and the concave portion that are additionally disposed are relatively small, which is not conducive to alignment of the first end cover 11 with the bottom housing 1a.

On the other hand, when the first end cover 11 and the bottom housing 1a are separated from each other, the chip mounting portion 111 protruding from the bottom housing 1a to the left side may further protect the driving force receiving member 15, the first driving member 81, the developing member driving member 82, and the toner conveying member driving member 83 in the up-down direction/third direction.

### Embodiment 4

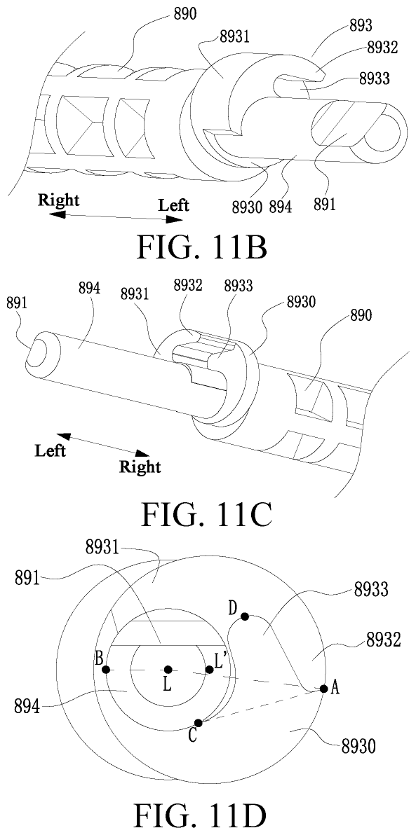

FIG. 11A is a three-dimensional diagram of a second driving member according to Embodiment 4 of the present invention; FIG. 11B and FIG. 11C are three-dimensional diagrams of a driving end of the second driving member according to Embodiment 4 of the present invention; and FIG. 11D is a side view of a rotation axis of the second driving member when the rotation axis is viewed from the driving end according to Embodiment 4 of the present invention.

The second driving member 89 includes a middle rod 890, a first combining portion 891 on the left side of the middle rod 890, and a force applying portion 893 between the middle rod and the first combining portion. The second driving member 89 is combined with a first driving member 81 by using the first combining portion 891, so that the second driving member 89 can rotate together with the first driving member 81. Preferably, the second driving member 89 further includes a rod body 894 (as shown in FIG. 11B) extending leftward from the middle rod 890, and the first combining portion 891 is disposed on the rod body 894.

The force applying portion 893 is set to be eccentric relative to a rotation axis L, that is, the force applying portion 893 is an eccentric portion (cam) disposed in the second driving member 89. As shown in the figures, a rotation axis of the middle rod 890 is L, a rotation axis of the force applying portion 893 is L′, the rotation axis L and the rotation axis L′ do not coincide, the force applying portion 893 has a far end point A away from the rotation axis L and a near end point B close to the rotation axis L. When a stirring member 5 presses against the far end point A, the stirring member 5 is pushed to the rearmost position in the front-back direction, and when the stirring member 5 presses against the near end point B, the stirring member 5 reaches the frontmost position in the front-back direction. The force applying portion 893 includes a base body 8931 connected to the rod body 894 or the middle rod 890 and an extension 8932 extending in a rotation direction from the base body 8931, and a spacing/avoidance portion 8933 is formed between the extension 8932 and the rod body 894 or the middle rod 890, that is, the extension 8932 is not connected to the rod body 894. When the stirring member 5 moves toward the second driving member 89, the avoidance portion 8933 may allow a part of the stirring member 5 to enter, thereby providing a larger moving space for the stirring member 5, so that the stirring member 5 can move forward a longer distance, and correspondingly, toner can be conveyed forward further by the stirring member 5 and is closer to the developing member 2.

It is assumed that the force applying portion 893 is not provided with the avoidance portion 8933. In this case, the force applying portion 893 is solid, an end thereof is shown as a dotted line AC in FIG. 11D, and in a working process of the developing cartridge 100, the stirring member 5 presses against a surface shown by the dotted line AC. However, in this embodiment, after reaching the position of the surface shown by the dotted line AC, the stirring member 5 can continue to move toward the bottom end D of the avoidance portion 8933, that is, the stirring member 5 in this embodiment can move more by a distance from the bottom end D to the dotted line AC.

Further, the force applying portion 893 further includes a base plate 8930 that is combined with the middle rod 890 or the rod body 894. The base plate 8930 extends by using the rotation axis L′ as a center, and the base body 8931 and/or the extension 8932 extend/extends in the left-right direction from the base plate 8930, so that overall structural strength of the force applying portion 893 is improved, especially when the avoidance portion 8933 is disposed, the structure of the force applying portion 893 is more stable.

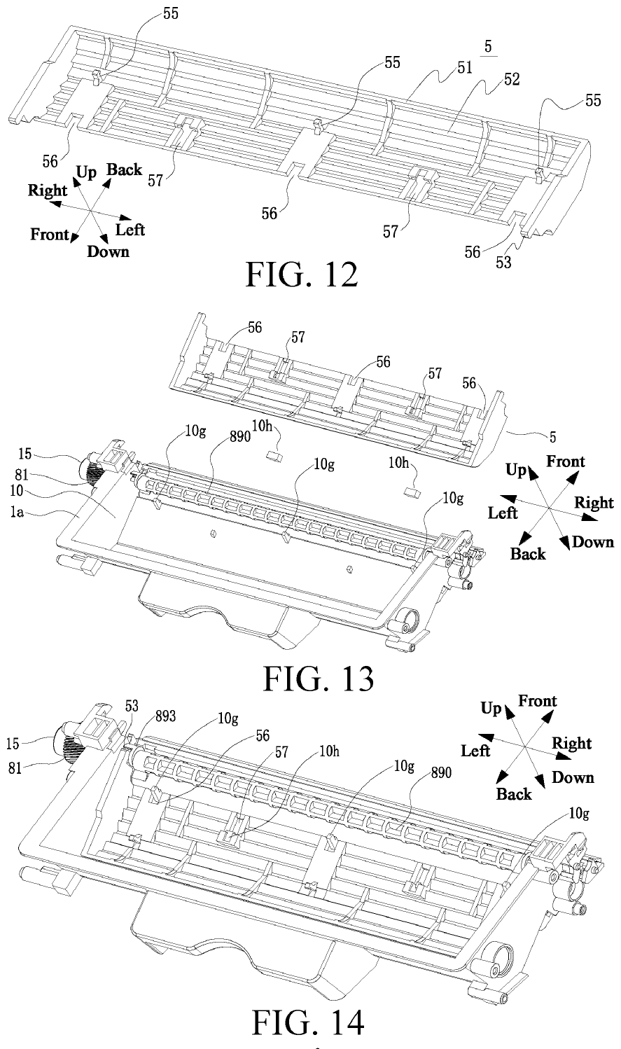

FIG. 12 is a three-dimensional diagram of the stirring member according to Embodiment 4 of the present invention; FIG. 13 is a diagram of a state after the stirring member and the housing are separated according to Embodiment 4 of the present invention; and FIG. 14 is a diagram of a state after the stirring member is mounted to the housing according to Embodiment 4 of the present invention.

As shown in FIG. 4 and FIG. 5, in addition to the foregoing structure, the stirring member 5 further includes a combination protrusion 55 and a guided portion/guide groove 56/57 that are disposed on the frame 51. The developing cartridge further includes a guide block 10g disposed on the housing 1. The guide block 10g is combined with the guided portion/guide groove 56/57, to ensure that the moving track of the stirring member 5 is stable in a reciprocating process of the stirring member 5. In addition, the guide block 10g further limits a forward movement distance of the stirring member 5 forward, to prevent the stirring member 5 from being too close to the developing member 2.

The developing cartridge further includes a tension spring 16 (an embodiment of an elastic member) that is combined with the combination protrusion 55. The tension spring 16 is further combined with the guide block 10g. In some embodiments, the guided portion/guide groove 56/57 is a through hole disposed on the frame 51. Further, the developing cartridge further includes a buffer member 10h disposed between the stirring member 5 and the housing 1. When the far end point A of the force applying portion 893 presses against the force receiving portion 53, the stirring member 5 is pushed to the rearmost position in the front-back direction, and the tension spring 16 is elongated. The force receiving portion 53 gradually approaches the near end point B as the second driving member 89 continues to rotate. Under a tensile force of the tension spring 16, the stirring member 5 is guided by the guide block 10g, the stirring member 5 gradually moves forward in a predetermined direction, and the toner is conveyed forward by the stirring member 5.

In a process of moving forward of the stirring member 5, the stirring member 5 presses against the buffer member 10h. In this case, a speed of moving forward of the stirring member 5 is reduced, the guide block 10g will not collide with the frame 51, or a collision force between the two is greatly reduced. In addition, a pressing force between the force receiving portion 53 and the force applying portion 893 is also reduced, and a friction force between the two is reduced. Finally, noise in a working process of the developing cartridge 100 is effectively controlled.

Generally, the buffer member 10h is a component that can move relative to the housing 1 after being pressed by the stirring member 5. For example, the buffer member 10h may be an elastic member, or may be a damping mechanism. After the buffer member 10h is pressed by the stirring member 5, an impact force of the stirring member 5 on the buffer member 10h is absorbed by the elastic member/damping mechanism, and a speed of the stirring member 5 moving from the back to the front is presented as fast at first and then slow.

The buffer member 10h may be mounted on the housing 1 without moving with the movement of the stirring member 5, or may be fixedly mounted on the stirring member 5 and moves with the movement of the stirring member 5. When the buffer member 10h is an elastic member, specifically, when the buffer member 10h is a sponge or a spring, at least one of the guided portion/guide groove 56/57 is disposed to have an opening in only the up-down direction, and on a plane perpendicular to the up-down direction, the guided portion/guide groove 56/57 is enclosed by the frame 51, and the sponge or spring may be mounted in the guided portion/guide groove 56/57, which is conductive to improving mounting stability of the buffer member 10h. When the buffer member 10h is a damping mechanism, specifically, when the buffer member 10h is a flexible friction member or the buffer member 10h is a combination of a gear transmission mechanism that can move relative to the housing 1 and a flexible friction member. Regardless of the composition and structure of the buffer member 10h, in a process in which the stirring member 5 moves from the front to the back, the buffer member 10h changes from a state of being combined with both the housing 1 and the stirring member 5 to a state of being combined with only one of the housing 1 and the stirring member 5, but on the contrary, in a process in which the stirring member 5 moves from the back to the front, the buffer member 10h changes from a state of being combined with only one of the housing 1 and the stirring member 5 to a state of being combined with both the housing 1 and the stirring member 5.

As described above, the developing cartridge in this embodiment includes the buffer member 10h disposed between the housing 1 and the stirring member 5. In the process in which the stirring member 5 moves from the back to the front, the stirring member 5 first presses against the buffer member 10h to reduce a movement speed, so that when the stirring member 5 and the guide block 10g that is disposed on the housing 1 no longer contact or contact each other, a force is reduced, and a pressing force between the stirring member 5 and the second driving member 89 is also reduced, thereby reducing working noise of the developing cartridge 100 and reducing a friction force between the stirring member 5 and the second driving member 89.

### Embodiment 5

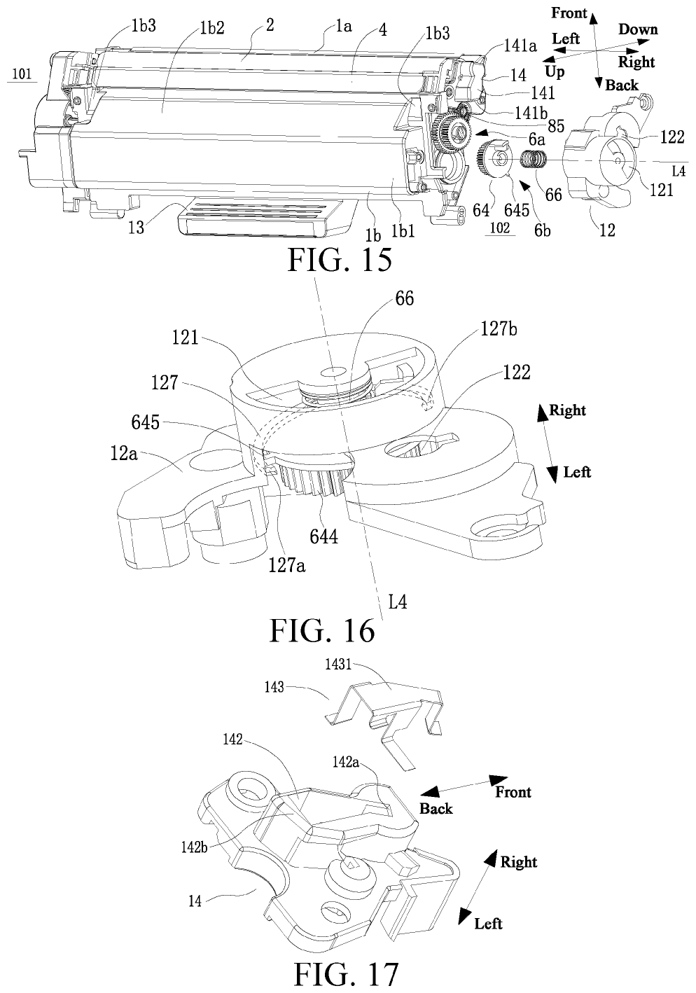

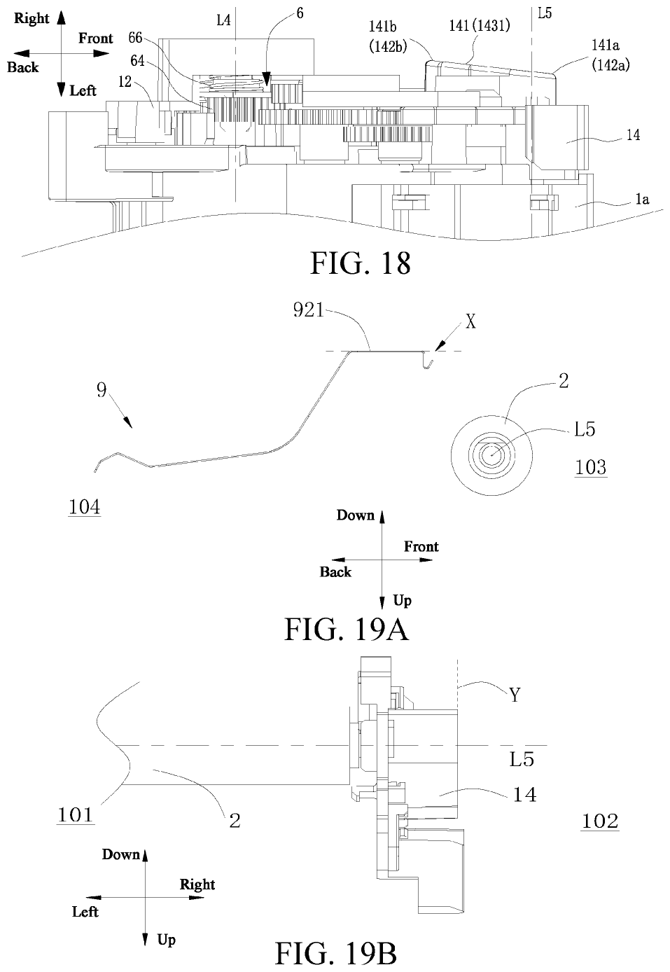

FIG. 15 is a schematic exploded view of some components on a counting side of a developing cartridge according to Embodiment 5 of the present invention; FIG. 16 is a three-dimensional diagram showing that a toggle portion of a counting assembly is mounted to an end cover according to Embodiment 5 of the present invention; FIG. 17 is a schematic exploded view of components of another conductive member according to Embodiment 5 of the present invention; and FIG. 18 is a side view of the developing cartridge viewed from bottom to top in an up-down direction of the developing cartridge according to Embodiment 5 of the present invention.

This embodiment is based on Embodiment 1 to improve the counting assembly 6. Therefore, in the following, reference is made to the numbers of the components in Embodiment 1. As shown in the figures, the top cover 1b includes a first portion 1b1 close to the handle 13 and a second portion 1b2 away from the handle 13 in the front-back direction. In other words, the first portion 1b1 is farther away from the adjustment member 4 than the second portion 1b2. Generally, the top cover 1b is combined with the bottom housing 1a through welding, and the second portion 1b2 is closer to the adjustment member 4. To prevent a laser beam emitted by the device from being shielded in a working process of the developing cartridge, the second portion 1b2 does not go beyond the first portion 1b1 in the up-down direction, and end portions 1b3 located on the left and right sides of the second portion 1b2 are disposed in an inclined shape, that is, the end close to the adjustment member 4 is closer to the bottom housing 1a than the end away from the adjustment member 4. However, this structure causes a complex structure of the top cover 1b. Therefore, the top cover 1b in the present invention is preferably disposed perpendicular to the up-down direction, that is, the top cover 1b is parallel to the left-right direction/front-back direction.

As shown in FIG. 15, the counting assembly 6 still includes a driving portion 6a for receiving a driving force and a toggle portion 6b driven by the driving portion 6a. The driving portion 6a receives a driving force from a driving gear 85. The toggle portion 6b includes a toggle member 64 and a restoring member 66 that are combined with each other. Under the driving of the driving portion 6a, the toggle member 64 is configured to interact with the detecting component 400, and the restoring member 66 is configured to force the toggle portion 6b to restore.

Preferably, the toggle member 64 has a full gear 644, and can move, along a rotation axis L4 of the toggle portion 6b, in a direction away from the housing 1/second end cover 12 and close to the housing 1/second end cover 12. In a counting process, the toggle member 64 is gradually away from the housing 1 along a preset guide rail, and the restoring member 66 is forced to be elastically deformed. When counting is completed, the toggle member 64 is pushed to the housing 1 under the action of an elastic restoring force of the restoring member 66. In this case, the toggle member 64 may be disposed to be no longer combined with the guide rail to disengage from the driving portion 6a, or the toggle member 64 may be disposed to be still combined with the driving portion 6a, but driving force transmission inside the driving portion 6a is interrupted.

The second end cover 12 has an inner surface 12b facing the housing 1 and an outer surface 12a away from the housing 1. The outer surface 12a faces the inner surface 12b along the rotation axis L. The second end cover 12 is provided with a first through hole 121 and a second through hole 122. A part of the toggle portion 6b is exposed through the first through hole 121, and a part of the driving portion 6a is exposed through the second through hole 122. Further, the second end cover 12 further has a cylinder extending from the inner surface 12b in a direction away from the outer surface 12a, a first protrusion portion 124 and a second protrusion portion 125 that extend from a free end of the cylinder, and a guide rail 127 disposed in a circumferential direction of the rotation axis L4. The first protrusion portion 124 and the second protrusion portion 125 are formed at intervals so that they can relatively move. The toggle portion 6b is sleeved to the cylinder. The guide rail 127 extends helically at an extension angle less than 360°. The guide rail 127 is a non-closed body when viewed along the rotation axis L4, and has a first end 127a and a second end 127b, where the second end 127b is farther away from the housing 1 than the first end 127a. Correspondingly, the toggle member 64 is provided with a guided portion 645 guided by the guide rail 127.

When the toggle portion 6b is mounted to the second end cover 12, the restoring member 66 is preferably a compression spring located between the toggle member 64 and the inner surface 12b of the second end cover. Optionally, the restoring member 66 may alternatively be a tension spring located between the toggle member 64 and the cylinder. In addition, the toggle member 64 is limited by at least one of the first protrusion portion 124 and the second protrusion portion 125, and does not fall off from the cylinder. In an initial phase when the counting assembly 6 starts counting, the guided portion 645 is located at the first end 127a of the guide rail. With the driving of the driving portion 6a, the toggle member 64 gradually moves away from the housing 1/approaches the inner surface 12b of the second end cover, and in this process, the toggle member 64 interacts with the detecting component 400 in the device. Upon completion of the counting, the guided portion 645 crosses the second end 127b, and the toggle member 64 is pushed in a direction close to the housing 1/a direction away from the inner surface 12b of the second end cover under the action of the elastic restoring force of the restoring member 66.

On the other hand, as shown in FIG. 15, the electrical interface 141 is disposed as an entire continuous plane, and is inclined relative to the front-back direction. In the front-back direction, the electrical interface 141 has a front conductive end 141a located at the front side and a rear conductive end 141b located at the rear side. In the left-right direction, the front conductive end 141a is closer to the housing 1 than the rear conductive end 141b, or from front to back in the front-back direction, the electrical interface 141 is gradually away from the housing 1. This arrangement can ensure that in a mounting process of the developing cartridge 100, the conductive member 14 is in smooth contact with a power output member in the device, to stably receive power, without causing an inclination deformation of the power output member. Preferably, the conductive member 14 is formed integrally. For example, the conductive member 14 is formed integrally by die casting of a metal part, or the conductive member 14 is formed integrally by injection molding of a conductive plastic.

FIG. 17 shows a structure of another conductive member 14. A mounting portion 142 is disposed on a main body of the conductive member 14, and a conductive sheet 143 is mounted in the mounting portion 142. The conductive sheet 143 has an electrical interface 1431 configured to receive power from the device, and the electrical interface 1431 is also an entire continuous plane. The main body of the conductive member 14 may be disposed to be conductive or non-conductive. After receiving the power, the conductive sheet 143 directly transmits the power to the developing member 2 or indirectly transmits the power to the developing member 2 through the main body of the conductive member.

As shown in FIG. 17 and FIG. 18, in the front-back direction, the mounting portion 142 also has a front conductive end 142a located at the front side and a rear conductive end 142b located at the rear side. In addition, in the left-right direction, the front conductive end 142a is closer to the housing 1 than the rear conductive end 142b, or from front to back in the front-back direction, the electrical interface 142 is gradually away from the housing 1. This arrangement can ensure that after the conductive sheet 143 is mounted, the electrical interface 1431 can achieve a same function as the foregoing electrical interface 141.

It may be implemented that, in addition to being disposed as a continuous plane, the electrical interface 141/1431 may alternatively be disposed as a continuous curved surface, and the continuous curved surface is smoothly transitioned. In the left-right direction, an end at the front side of the continuous curved surface is closer to the housing 1 than an end at the rear side of the continuous curved surface, or from front to back in the front-back direction, the continuous curved surface is gradually away from the housing 1.

As shown in FIG. 18, in the up-down direction, a projection of the front conductive end 142a/141a on the rotation axis L4/L5 is located on the left of a projection of the rear conductive end 142b/141b on the rotation axis L4/L5. In other words, the projection of the front conductive end 142a/141a on the rotation axis L4/L5 is closer to the housing 1 than the projection of the rear conductive end 142b/141b on the rotation axis L4/L5. More specifically, the projection of the front conductive end 142a/141a on the rotation axis L4/L5 is closer to the end that is of the developing member 2 and that is at the driving end 101 than the projection of the rear conductive end 142b/141b on the rotation axis L4/L5. In this way, in a process in which the developing cartridge 100 is mounted to the device in the front-back direction, using the electrical interface 141/1431 that is inclined relative to the front-back direction can ensure that the power output member in the device is stably pressed, to avoid an adverse situation in which the developing cartridge 100 is pushed by a counter-acting force of the power output member to cause shaking of the toggle portion 6b.

### Embodiment 6

FIG. 19A is a schematic diagram of a position relationship between a plane in which a projection, on a chip connection assembly, of a contact point between the chip connection assembly and a power terminal is located and a rotation axis of a developing member in an existing developing cartridge; and FIG. 19B is a schematic diagram of a position relationship between a plane in which a projection, on a conductive member, of a contact point between the conductive member and a power supply member is located and the rotation axis of the developing member in the existing developing cartridge.

In the existing developing cartridge, a plane X in which a projection, on a chip connection assembly, of a contact point between the chip connection assembly 9 and a power terminal in a device/an electrical contact 011 of a printer is located and a rotation axis L5 of a developing member are parallel to each other, and a plane Y in which a projection, on a conductive member, of a contact point between the conductive member 14 and a power supply member is located and the rotation axis L5 of the developing member are perpendicular to each other. Therefore, the plane X and the plane Y are perpendicular to each other. When the developing cartridge is mounted in the device, to ensure that the power supply member and the power terminal in the device simultaneously contact the conductive member 14 and the chip connection assembly 9 of the developing cartridge, it is clear that a requirement for position accuracy of the conductive member 14 and the power supply member as well as the chip connection assembly 9 and the power terminal needs to be improved.

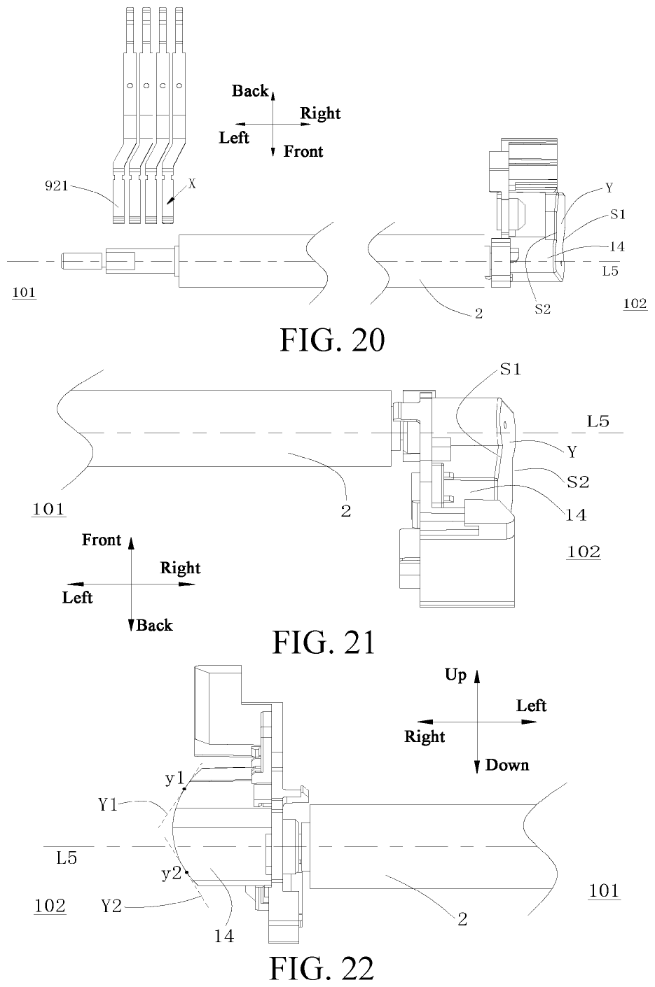

FIG. 20 is a schematic diagram of the position relationship between the plane in which the projection, on the conductive member, of the contact point between the conductive member and the power supply member is located and the rotation axis of the developing member and the position relationship between the plane in which the projection, on the chip connection assembly, of the contact point between the chip connection assembly and the power terminal is located in the developing cartridge according to Embodiment 6 of the present invention.

In the following, to view the position relationship between the plane X and the plane Y more clearly, only the chip connection assembly 9, the developing member 2, and the conductive member 14 are shown in the figure.

As shown in FIG. 20, by projecting from the lower side to the upper side of the developing cartridge 100, it may be viewed that the plane X in which the projection, on the chip connection assembly 9, of the contact point between the chip connection assembly 9 and the power terminal is located and the rotation axis L5 of the developing member 2 are parallel to each other. The plane Y in which the projection, on the conductive member 14, of the contact point between the conductive member 14 and the power supply member is located is inclined in the left-right direction. In the up-down direction, the plane Y includes a first end S1 and a second end S2 that are separated from each other. In the left-right direction, the first end S1 is farther away from the developing member 2 than the second end S2, and the first end S1 is on the right of the second end S2. Therefore, the plane Y in which the projection, on the conductive member 14, of the contact point between the conductive member 14 and the power supply member is located is not perpendicular to the rotation axis L5 of the developing member 2, so that the plane Y in which the projection, on the conductive member 14, of the contact point between the conductive member 14 and the power supply member is located is not perpendicular to the plane X in which the projection, on the chip connection assembly 9, of the contact point between the chip connection assembly 9 and the power terminal is located.

On the one hand, the plane Y is not perpendicular to the rotation axis L5, and device resistance on the developing cartridge 100 during mounting and removal is reduced. On the other hand, even if the position of the power supply member in the device slightly changes, the power supply member can still contact the inclined plane, thereby reducing the requirement for the position accuracy of the conductive member 14 and the power supply member.

### Embodiment 7

FIG. 21 is a schematic diagram of a position relationship between a plane in which a projection, on a conductive member, of a contact point between the conductive member and a power supply member is located and a rotation axis of a developing member in a developing cartridge according to Embodiment 7 of the present invention.

To view the position relationship between the plane Y and the rotation axis L5 more clearly, only the conductive member 14 and the developing member 2 are shown in the figure.

A difference between this embodiment and Embodiment 6 lies in that an inclination direction of the plane Y is opposite to an inclination direction of the plane Y in Embodiment 6.

As shown in FIG. 21, the plane X in which the projection, on the chip connection assembly 9, of the contact point between the chip connection assembly 9 and the power terminal is located and the rotation axis L5 of the developing member 2 are parallel to cach other (as shown in FIG. 20). By projecting from the upper side to the lower side of the developing cartridge 100, it may be viewed that plane Y in which the projection, on the conductive member 14, of the contact point between the conductive member 14 and the power supply member is located is inclined in the left-right direction. In the up-down direction, the plane Y includes the first end S1 and the second end S2 that are separated from each other. In the left-right direction, the first end S1 is closer to the developing member 2 than the second end S2, and the first end S1 is on the left of the second end S2. Therefore, the plane Y in which the projection, on the conductive member 14, of the contact point between the conductive member 14 and the power supply member is located is not perpendicular to the rotation axis L5 of the developing member 2, so that the plane Y in which the projection, on the conductive member 14, of the contact point between the conductive member 14 and the power supply member is located is not perpendicular to the plane X in which the projection, on the chip connection assembly 9, of the contact point between the chip connection assembly 9 and the power terminal is located.

On the one hand, the plane Y is not perpendicular to the rotation axis L5, and device resistance on the developing cartridge 100 during mounting and removal is reduced. On the other hand, even if the position of the power supply member in the device slightly changes, the power supply member can still contact the inclined plane, thereby reducing the requirement for the position accuracy of the conductive member 14 and the power supply member.

### Embodiment 8

FIG. 22 is a schematic diagram of a position relationship between a plane in which a projection, on a conductive member, of a contact point between the conductive member and a power supply member is located and a rotation axis of a developing member in a developing cartridge according to Embodiment 8 of the present invention.

To view the position relationship between the plane Y and the rotation axis L5 more clearly, only the conductive member 14 and the developing member 2 are shown in the figure.

This embodiment differs from the foregoing embodiments in that an end of the conductive member 14 is an arc surface.

As shown in FIG. 22, the plane X in which the projection, on the chip connection assembly 9, of the contact point between the chip connection assembly 9 and the power terminal is located and the rotation axis L5 of the developing member 2 are parallel to each other (as shown in FIG. 20). By projecting from the front end 103 to the rear end 104 of the developing cartridge 100, it may be viewed that the end of the conductive member 14 is in an arc shape. Therefore, there are at least two types of planes (tangent planes along the arc surface) in which projections, on the conductive member 14, of contact points such as y1 and y2 between the conductive member 14 and the power supply member on the arc surface are located, for example, a plane Y1 and a plane Y2. The plane Y1 faces the upper side of the developing cartridge 100, the plane Y2 faces the lower side of the developing cartridge 100, and neither the plane Y1 nor the plane Y2 is perpendicular to the rotation axis L5 of the developing member 2, so that the plane Y (a tangent plane along the arc surface) in which the projection, on the arc surface of the conductive member 14, of the contact point between the conductive member 14 and the power supply member is located is not perpendicular to the plane X in which the projection, on the chip connection assembly 9, of the contact point between the chip connection assembly 9 and the power terminal is located.

On the one hand, the plane Y is not perpendicular to the rotation axis L5, and device resistance on the developing cartridge 100 during mounting and removal is reduced. On the other hand, even if the position of the power supply member in the device slightly changes, the power supply member can still contact the arc surface, thereby reducing the requirement for the position accuracy of the conductive member 14 and the power supply member.

In this embodiment, there are three contact manners between the device and the conductive member 14. The first manner is that the device only contacts the plane Y1, the second manner is that the device only contacts the plane Y2, and the third manner is that the device contacts both the plane Y1 and the plane Y2. Regardless of a manner in which the device contacts the conductive member 14, the plane Y1 and the plane Y2 cach may present a different angle based on a different position of the power supply member. Therefore, the conductive member 14 in this embodiment may be applicable to a plurality of types of devices, and has better universality.

### Embodiment 9

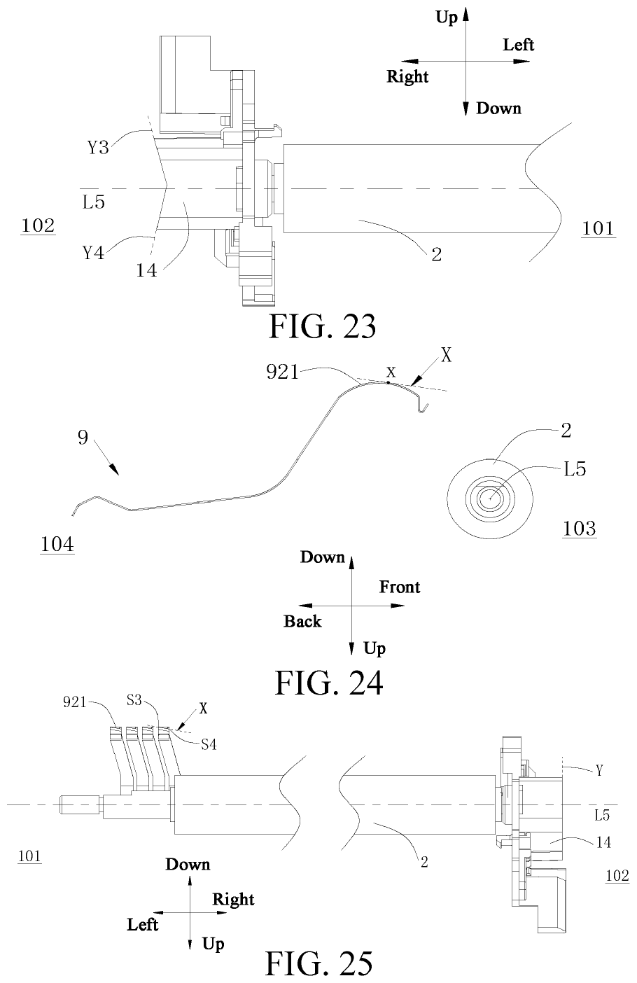

FIG. 23 is a schematic diagram of a position relationship between a plane in which a projection, on a conductive member, of a contact point between the conductive member and a power supply member is located and a rotation axis of a developing member in a developing cartridge according to Embodiment 9 of the present invention.

To view the position relationship between the plane Y and the rotation axis L5 more clearly, only the conductive member 14 and the developing member 2 are shown in the figure.

This embodiment differs from the foregoing embodiments in that in this embodiment, an end of the conductive member 14 is a V-shaped plane and includes two planes.

As shown in FIG. 23, the plane X in which the projection, on the chip connection assembly 9, of the contact point between the chip connection assembly 9 and the power terminal is located and the rotation axis L5 of the developing member 2 are parallel to each other (as shown in FIG. 20). By projecting from the front end 103 to the rear end 104 of the developing cartridge 100, it may be viewed that the end of the conductive member 14 is V-shaped, and the conductive member 14 is recessed from the end thereof. Therefore, there are two planes in which projections, on the conductive member, of contact points between the conductive member 14 and the power supply member are located, that is, a plane Y3 and a plane Y4. The plane Y3 faces the lower side of the developing cartridge 100, the plane Y4 faces the upper side of the developing cartridge 100, and neither the plane Y3 nor the plane Y4 is perpendicular to the rotation axis L5 of the developing member 2, so that the plane Y in which the projection, on the conductive member 14, of the contact point between the conductive member 14 and the power supply member is located is not perpendicular to the plane X in which the projection, on the chip connection assembly 9, of the contact point between the chip connection assembly 9 and the power terminal is located.

On the one hand, the plane Y is not perpendicular to the rotation axis L5, and device resistance on the developing cartridge 100 during mounting and removal is reduced. On the other hand, even if the position of the power supply member in the device slightly changes, the power supply member can still contact the inclined plane, thereby reducing the requirement for the position accuracy of the conductive member 14 and the power supply member.

In this embodiment, there are three contact manners between the device and the conductive member 14. The first manner is that the device only contacts the plane Y3, the second manner is that the device only contacts the plane Y4, and the third manner is that the device contacts both the plane Y3 and the plane Y4. As in Embodiment 8, the conductive member 14 in this embodiment may be applicable to a plurality of types of devices, and has good universality.

### Embodiment 10

FIG. 24 is a schematic diagram of a position relationship between a plane in which a projection, on a chip connection assembly, of a contact point between the chip connection assembly and a power terminal is located and a rotation axis of a developing member in a developing cartridge according to Embodiment 10 of the present invention.

To view the position relationship between the plane X and the rotation axis L5 more clearly, only the chip connection assembly 9 and the developing member 2 are shown in the figure.

This embodiment differs from the foregoing embodiments in that in this embodiment, a first contact portion 921 of the chip connection assembly 9 is disposed as an arc surface based on different arrangements of the conductive members 14 in Embodiment 6 to Embodiment 9.

As shown in FIG. 24, by projecting from a driving end 101 of the developing cartridge 100 to a conductive end 102, it may be viewed that the first contact portion 921 is in an arc shape. Therefore, there is at least one plane (a tangent plane along an arc surface) in which the projection, on the chip connection assembly, of the contact point x, on the arc surface, between the chip connection assembly 9 and the power terminal is located, for example, the plane X. The plane X and the rotation axis L5 of the developing member 2 are parallel to each other. In Embodiment 6 to Embodiment 9, the plane Y in which the projection, on the conductive member 14, of the contact point between the conductive member 14 and the power supply member is located is not perpendicular to the rotation axis L5 of the developing member 2. Therefore, the plane X (the tangent plane along the arc surface) in which the projection, on the chip connection assembly 9, of the contact point, on the arc surface, between the chip connection assembly 9 and the power terminal is located is not perpendicular to the plane Y in which the projection, on the conductive member 14, of the contact point between the conductive member 14 and the power supply member is located.

On the one hand, the plane Y is not perpendicular to the rotation axis L5, and device resistance on the developing cartridge 100 during mounting and removal is reduced. On the other hand, even if the position of the power supply member in the device slightly changes, the power supply member can still contact the inclined surface or arc surface, thereby further reducing the requirement for the position accuracy of the conductive member 14 and the power supply member.

### Embodiment 11

FIG. 25 is a schematic diagram of a position relationship between a plane in which a projection, on a chip connection assembly, of a contact point between the chip connection assembly and a power terminal is located and a rotation axis of a developing member and a position relationship between the plane and a plane in which a projection, on a conductive member, of a contact point between the conductive member and a power supply member is located in a developing cartridge according to Embodiment 11 of the present invention.

To view the position relationship between the plane X and the plane Y more clearly, only the chip connection assembly 9, the developing member 2, and the conductive member 14 are shown in the figure.

This embodiment differs from Embodiment 10 in that in this embodiment, the first contact portion 921 of the chip connection assembly 9 is disposed as an inclined plane. In the following, an example in which an end of the conductive member 14 is disposed as the plane Y perpendicular to the rotation axis L5 of the developing member 2 is used for description.

As shown in FIG. 25, by projecting from the front end 103 to the rear end 104 of the developing cartridge 100, the first contact portion 921 of the chip connection assembly 9 is disposed as a plane inclined to the right side of the developing cartridge 100. In the left-right direction, the plane X includes a first end S3 and a second end S4 that are separated from each other. In the up-down direction, the first end S3 is farther away from the developing member 2 than the second end S4, and the first end S3 is below the second end S4. Alternatively, the first contact portion 921 may be disposed as a plane inclined to the left side of the developing cartridge 100. In the up-down direction, the first end S3 of the plane X is closer to the developing member 2 than the second end S4, and the first end S3 is above the second end S4. In this case, the plane X in which the projection, on the chip connection assembly 9, of the contact point between the chip connection assembly 9 and the power terminal is located is not parallel to the rotation axis L5 of the developing member 2. Therefore, the plane X in which the projection, on the chip connection assembly 9, of the contact point between the chip connection assembly 9 and the power terminal is located is not perpendicular to the plane Y in which the projection, on the conductive member 14, of the contact point between the conductive member 14 and the power supply member is located.

On the one hand, the plane X is not parallel to the rotation axis L5, and device resistance on the developing cartridge 100 during mounting and removal is reduced. On the other hand, even if the position of the power terminal in the device slightly changes, the power terminal can still contact the inclined plane, thereby reducing the requirement for the position accuracy of the chip connection assembly 9 and the power terminal.

It may be understood that any two of Embodiment 6 to Embodiment 11 may be combined, provided that the plane X in which the projection, on the conductive member, of the contact point between the conductive member 14 and the power supply member is located in the developing cartridge is not perpendicular to the rotation axis of the developing member, or that the plane Y in which the projection, on the chip connection assembly, of the contact point between the chip connection assembly 9 and the power terminal is located in the developing cartridge is not parallel to the rotation axis of the developing member, or that the plane X in which the projection, on the conductive member, of the contact point between the conductive member 14 and the power supply member is located is not perpendicular to the plane Y in which the projection, on the chip connection assembly, of the contact point between the chip connection assembly 9 and the power terminal is located, all of which belong to an inventive concept of the present invention. Therefore, the following beneficial effects can be brought: Device resistance on the developing cartridge during mounting and removal is reduced, and even if the position of the power supply member or power terminal in the device slightly changes, the conductive member 14 and the chip connection assembly 14 can still be in good electrical contact, and correspondingly, the requirement for position accuracy of the conductive member 14 and the power supply member as well as the chip and the power terminal is reduced.

### Embodiment 12

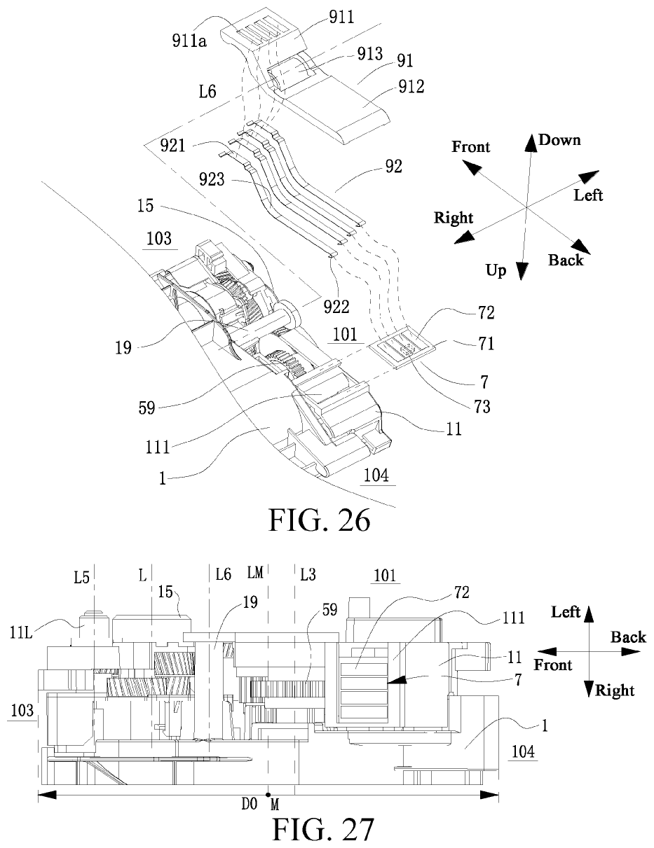

FIG. 26 is a schematic exploded view of a chip connection assembly in a developing cartridge according to Embodiment 12 of the present invention; and FIG. 27 is a side view of the developing cartridge when the developing cartridge is viewed from bottom to top in an up-down direction after a chip mounting assembly is hidden according to Embodiment 12 of the present invention.

As shown in FIG. 3 and FIG. 26, the first end cover 11 or the housing 1 is further provided with the chip mounting portion/an electrical connection area 111 for mounting the chip 7, and the chip connection assembly 9 that can enable an electrical connection between the electrical contact 72 and the device to be broken and then a communication connection not to be established between the electrical contact and the device and that can enable an electrical connection to be established between the electrical contact 72 and the device to establish a communication connection between the electrical contact 72 and the device.

In the front-back direction, at least the electrical contact 72 is disposed away from the driving force receiving member 15. As shown in FIG. 27, a size of the developing cartridge 100 in the front-back direction is DO with a midpoint M, a midline LM passes through the midpoint M and is parallel to the left-right direction, the driving force receiving member 15 and the electrical contact 72 are respectively located on two sides of the midline LM, and the electrical contact 72 is closer to rear end 104 than the driving force receiving member 15, or the driving force receiving member 15 is closer to the front end 103 than the electrical contact 72. Therefore, vibration impact generated by the driving force receiving member 15 during rotation on the electrical contact 72 is reduced.

Further, when the stirring member is disposed to rotate around an axis, the developing cartridge 100 further includes the stirring member (not shown) located in the housing 1 and a driving member 59 (as shown in FIG. 27) configured to drive the stirring member to move. The driving member 59 is driven by the driving force of the driving force receiving member 15, and the stirring member is configured to stir toner in the housing to prevent the toner from caking. In the front-back direction, at least the electrical contact 72 is located on the rear side of a rotation axis L3 of the driving member 59/stirring member, to further reduce impact, on the electrical contact 72, of vibration generated when the driving force of the driving force receiving member 15 is transmitted to each component in the developing cartridge.

As described above, the developing cartridge 100 further includes the chip connection assembly 9, and at least a part of the chip connection assembly 9 is a movable member that can move relative to the housing 1. When the movable member is in a first position, the movable member enables the electrical connection between the electrical contact 72 and the device to be broken and then a communication connection cannot be established between the electrical contact and the device, and when the movable member is in a second position, the movable member enables an electrical connection to be implemented between the electrical contact 72 and the device to establish a communication connection between the electrical contact and the device. Before the developing cartridge 100 is mounted to the drum holder 200 or the device, the movable member is in the first position. In a process in which the developing cartridge 100 is mounted to the drum holder 200 or the device, the movable member moves from the first position to the second direction under the action of an external force. According to the foregoing description, when the developing cartridge 100 is directly mounted to the device, a conductor described below is electrically connected to the electrical contact 72 and the power terminal respectively as the movable member reaches the second position. In this case, the electrical contact 72 is electrically connected to the device to establish a communication connection. When the developing cartridge 100 is mounted to the drum holder 200 but the combination of the developing cartridge 100 and the drum holder 200 has not been mounted to the device, after the movable member reaches the second position, the conductor is electrically connected to the electrical contact 72, but the conductor has not been electrically connected to the power terminal. However, provided that the combination is mounted to a predetermined position on the device, the conductor is electrically connected to the power terminal. In this case, the conductor is electrically connected to the electrical contact 72 and the power terminal respectively, and the electrical contact 72 is electrically connected to the device to establish a communication connection. When the developing cartridge 100 is removed, the movable member returns to the first position again. Because the movable member is disposed to be movable, in a working process of the developing cartridge 100, even if vibration generated by the driving force receiving member 15 is transmitted to the chip connection assembly 9/movable member, the chip connection assembly 9/movable member can also eliminate impact of the vibration through a structure of the chip connection assembly 9/movable member.

In this embodiment, the movable member is mounted in a manner that the movable member can rotate around a rotation axis L6, and the rotation axis L6 is parallel to the rotation axis L/L5. As shown in FIG. 26, the chip connection assembly 9 includes a mounting plate 91 and a conductor 92 mounted on the mounting plate 91. The mounting plate 91 is disposed to rotate around the rotation axis L6, and the conductor 92 may rotate with rotation of the mounting plate 91. Therefore, any one or a combination of the mounting plate 91 and the conductor 92 may be considered as a movable member. Generally, the mounting plate 91 is made of a non-conductive material, and the conductor 92 is made of a conductive material. For example, the conductor 92 is formed by die casting of a metal sheet, and a quantity of the conductors 92 corresponds to a quantity of electrical contacts 72. The following uses this as an example for description. Simplistically, the conductor 92 is made of a conductive resin, and the mounting plate 91 and the conductor 92 are formed integrally by injection molding.

The conductor 92 includes a first contact portion 921/lower end 3121, a second contact portion 922/upper end 3122, and a connector 923/central portion 3123 for connecting the first contact portion 921 to the second contact portion 922. The first contact portion 921 is configured to electrically connect to the power terminal in the device, to obtain an electrical signal, and the second contact portion 922 is configured to electrically connect to the electrical contact 72, so that the device and the electrical contact 72 are electrically connected. A conductor mounting groove (not shown) is disposed on the mounting plate 91, and cach conductor 92 is mounted in a corresponding mounting groove, to avoid a problem of a short circuit between adjacent conductors. As shown in the figure, the mounting plate 91 includes a first mounting portion 911, a second mounting portion 912, and an acted-upon portion 913 located between the first mounting portion and the second mounting portion. The acted-upon portion 913 is configured to combine with a support shaft 19 disposed on the housing 1 or the first end cover 11, so that the mounting plate 91 can rotate around the support shaft 19.

The first mounting portion 911 is configured to carry the first contact portion 921, and the second mounting portion 912 is configured to carry the second contact portion 922. Further, the mounting groove forms a through hole 911a in the first mounting portion 911. Therefore, the first contact portion 921 is exposed through the through hole 911a.

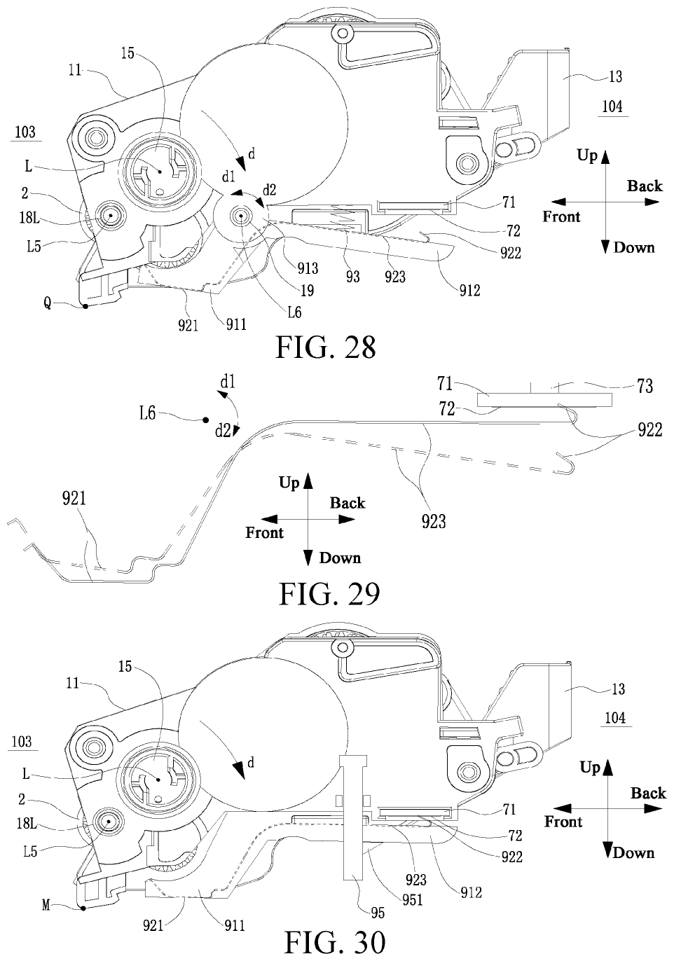

FIG. 28 is a side view of viewing a position of the chip mounting assembly in the developing cartridge from left to right in the left-right direction before the developing cartridge is mounted to the drum holder according to Embodiment 12 of the present invention; and FIG. 29 is a comparison diagram of states of a conductive sheet in the chip connection assembly before and after the developing cartridge is mounted according to Embodiment 12 of the present invention.

Before the developing cartridge 100 is mounted to the drum holder 200 or the device, the mounting plate 91/conductor 92 is in a first position shown in FIG. 28. The first mounting portion 911/first contact portion 921 is located above the lowest point Q of the developing cartridge 100, and the second contact portion 922 is located below the electrical contact 72 and the two are separated and disconnected from each other. Therefore, in a mounting process of the developing cartridge 100, the first contact portion 921 may be protected by the housing 1/first end cover 11 without friction and contact with the drum holder 200 or an inner wall of the device. In addition, the chip 7 and the second contact portion 922 are protected by the second mounting portion 912 without friction and contact with the drum holder 200 or the inner wall of the device. Even if an amplitude of a mounting action is large and the first mounting portion 911/first contact portion 921 experiences friction and contact with the drum holder 200 or the inner wall of the device, the second contact portion 922 does not contact the electrical contact 72, thereby avoiding friction and contact between the second contact portion 922 and the electrical contact 72, and reducing a wear probability of the chip 7.

Further, the chip connection assembly 9 further includes a first pushing member 93 that is combined with the mounting plate 91 or the conductor 92. The first pushing member 93 is configured to push the mounting plate 91, so that the mounting plate 91 has a trend of rotating around the rotation axis L6 in a direction (clockwise) shown by d2, that is, a trend in which the second contact portion 922 is away from the electrical contact 72/housing 1 and the first contact portion 921 approaches the driving force receiving member 15. Preferably, the first pushing member 93 is a compression spring mounted between the second mounting portion 912 and the housing 1/first end cover 11, or the first pushing member 93 is a tension spring mounted between the first mounting portion 911 and the housing/first end cover 11.

It may be implemented that the first pushing member 93 may be canceled. By setting the weight of the first mounting portion 911 to be lighter than the weight of the second mounting portion 912, the mounting plate 91/conductor 92 is kept in the first position, and by using a lever principle, when the weight of the second mounting portion 912 is greater than the weight of the first mounting portion 911, the movable member has a trend of rotating around the rotation axis L6 in a direction shown by d2.

As the developing cartridge 100 is mounted to the drum holder 200 or the device, a support portion 18L/18R enters a fastening groove 204 disposed in the drum holder 200 or the device, and rotates downward around the support portion 18L/18R in a direction shown by d (clockwise). When the second mounting portion 912 touches a baseplate 208 of the drum holder or an inner wall of the device, the movable member forces the first pushing member 93 to be elastically deformed and rotate around the rotation axis L6 in a direction d1 (counter-clockwise) opposite to that shown by d2. When the developing cartridge 100 is mounted to a predetermined position, the second contact portion 922 contacts the electrical contact 72, and the first contact portion 921 is connected to the device through an opening 209 of the drum holder or is directly connected to the device. Finally, a communication connection is established between the electrical contact 72 and the device.

FIG. 29 shows a position comparison of the conductor 92 in the first position and the second position, where the dotted lines in FIG. 28 and FIG. 29 indicate that the conductor 92 is in the first position and the solid lines indicate that the conductor 92 is in the second position. As shown in FIG. 29, when the conductor 92 is in the first position, there is a first distance between the first contact portion 921 and the rotation axis L6 in the up-down direction, and when the conductor 92 is in the second position, there is a second distance between the first contact portion 921 and the rotation axis L6 in the up-down direction, where the first distance is less than the second distance.

### Embodiment 13

FIG. 30 is a side view of viewing a position of a chip mounting assembly in a developing cartridge from left to right in a left-right direction before the developing cartridge is mounted to a drum holder according to Embodiment 13 of the present invention.

This embodiment differs from the foregoing embodiments in that the mounting plate 91/conductor 92 used as a movable member is disposed to slide in the up-down direction without rotating around the rotation axis L6.

As shown in FIG. 30, the chip connection assembly 9 further includes a movable rod 95 that is combined with the mounting plate 91, and the mounting plate 91 is supported by a support platform 951 disposed on the movable rod 95. Therefore, the mounting plate 91 and the conductor 92 located on the mounting plate 91 may move in the up-down direction with the movable rod 95. Before the developing cartridge 100 is mounted to the drum holder 200 or the device, the mounting plate 91/conductor 92 is in the first position. In this case, the second contact portion 922 is located below the electrical contact 72, and is separated from the electrical contact 72 to break an electrical connection. When the developing cartridge 100 is mounted to the drum holder 200 or a predetermined position on the device, the movable rod 95 is pressed by the baseplate 208 of the drum holder or the inner wall of the device, so that the mounting plate 91/conductor 92 moves upward to the second position, the second contact portion 922 contacts the electrical contact 72 to implement an electrical connection, and the first contact portion 921 is exposed through the first mounting portion 911. When the developing cartridge 100 is removed, the movable rod 95 is no longer pressed. Under the action of gravity, the movable rod 95 moves downward, and the mounting plate 91/conductor 92 returns from the second position to the first position. In processes of mounting and removing the developing cartridge 100, the chip 7 and the second contact portion 922 are protected by the second mounting portion 912 without friction and contact with the drum holder 200 or the inner wall of the device.

### Embodiment 14

In this embodiment, the mounting plate 91/conductor 92 used as a movable member is disposed to slide along a plane that intersects the up-down direction, and the movable member also has the foregoing first position and the foregoing second position. In the first position, the second contact portion 922 is separated from the electrical contact 72 to break an electrical connection; and in the second position, the second contact portion 922 contacts the electrical contact 72 to implement an electrical connection.

It may be implemented that the sliding of the movable member may be performed in the front-back direction, may be performed in the left-right direction, or may be performed in an inclination direction that is inclined relative to the up-down direction. In addition, the developing cartridge 100 is further provided with a restoring member that is combined with the movable member and that is configured to force the movable member to move toward the first position. As the developing cartridge 100 is mounted to the drum folder 200 or the device, the movable member is pushed by using the drum folder 200 or a part of the device to move from the first position to the second position, so that the restoring member is elastically deformed. When the developing cartridge 100 is removed, the movable member returns from the second position to the first position under the action of a restoring force of the restoring member. Similarly, in the processes of mounting and removing the developing cartridge 100, the second mounting portion 912 is located below the chip 7 and the second contact portion 922, and the chip 7 and the second contact portion 922 do not experience friction and contact with the drum holder 200 or inner wall of the device.

### Embodiment 15

In the foregoing embodiments, the mounting plate 91/conductor 92 used as a movable member is disposed to be movable as a whole. However, due to a size and space of the developing cartridge 100, only a part of the mounting plate 91/conductor 92 is movable, which is more conducive to an integral structural design of the developing cartridge 100.

Therefore, the movable member in this embodiment includes the second mounting portion 912 and the second contact portion 922 mounted in the second mounting portion 912. The first mounting portion 911 and the first contact portion 921 together are fixedly mounted on the housing 1 or the first end cover 11 as a fixed portion of the chip connection assembly 9. In this embodiment, the movable member may move between the foregoing first position and the foregoing second position in a rotating or sliding manner. The second mounting portion 912 and the second contact portion 922 are located on the movable member. In the first position, the second contact portion 922 is at least separated from the electrical contact 72 to break an electrical connection. In the second position, the second contact portion 922 contacts the electrical contact 72 to implement an electrical connection.

In both the first position and the second position, the movable member and the fixed portion may be electrically connected to each other. Preferably, in the first position, the second contact portion 922 is further disposed to be separated from the first contact portion 921 to break an electrical connection, that is, in this case, the movable member is located below the fixed portion and is electrically disconnected from the fixed portion, and in the second position, the second contact portion 922 simultaneously contacts the first contact portion 921 and the electrical contact 72 to implement an electrical connection. In this embodiment, in processes of mounting and removing the developing cartridge 100, the first contact portion 921 that is fixedly disposed is protected by the first mounting portion 911 from easily experiencing friction and contact with the drum holder 200 or the inner wall of the device. Even if the first contact portion 921 fails upon friction and contact, an end user may replace only the first contact portion 921 or replace the first contact portion 921 together with the first mounting portion 911, and the chip 7 with a higher value does not experience friction and contact.

### Embodiment 16

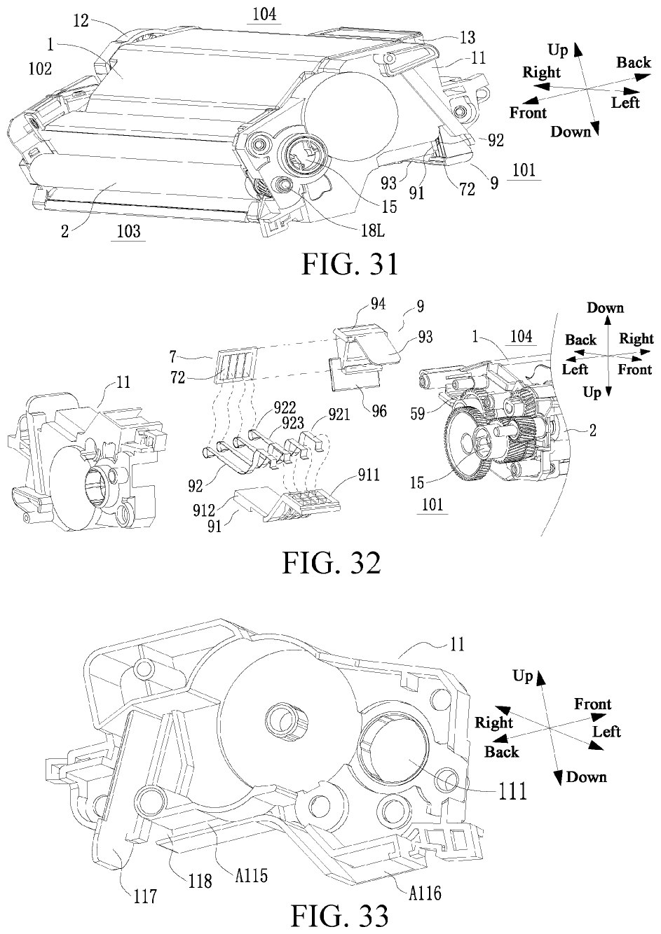

FIG. 31 is a three-dimensional diagram of a developing cartridge when the developing cartridge is viewed from a driving end according to Embodiment 16 of the present invention; and FIG. 32 is a schematic exploded view of a chip connection assembly in the developing cartridge according to Embodiment 16 of the present invention.

In the foregoing embodiments, the chip 7/electrical contact 72 is fixed, and the mounting plate 91/conductor 92 used as a movable member moves between the first position and the second position in which the movable member is electrically connected to and electrically disconnected from the electrical contact 72. As described in Embodiment 15, when the entire mounting plate 91/conductor 92 moves, it may be limited by the size and internal space of the developing cartridge 100. Relatively, the chip 7 or the electrical contact 72 has a smaller size. In the following, an example in which the chip 7/electrical contact 72 is movable is used for description.

As shown in FIG. 31 and FIG. 32, the chip connection assembly 9 includes a movable member 94 that is movable relative to the housing 1 as well as the mounting plate 91 and the conductor 92 that are immovable relative to the housing 1. At least the electrical contact 72 is mounted in the movable member 94. In this case, the mounting plate 91 and the conductor 92 form a fixed portion. Preferably, the entire chip 7 is mounted in the movable member 94. As in Embodiment 12, the mounting plate 91 may be made of a conductive material or may be made of a non-conductive material. The mounting plate 91 may be formed integrally or separately with the conductor 92. The mounting plate 91 has a first mounting portion 911, a second mounting portion 912, and a conductor mounting groove. The conductor 92 has a first contact portion 921, a second contact portion 922, and a connector 923 for connecting the first contact portion to a second contact portion. The first contact portion 921 is configured to be electrically connected to the device, and the second contact portion 922 is configured to be electrically connected to the electrical contact. In a simplified structure, the mounting plate 91 may be omitted, and the conductor 92 is fixed to the first end cover 11 or the housing 1, and an objective of the present invention can still be implemented.

The movable member 94 may be mounted on the first end cover 11, or may be mounted on the housing 1. Before the developing cartridge 100 is mounted to the drum holder 200 or the device, the movable member 94 is located in the first position, and the second contact portion 922 is located below the electrical contact 72, and is separated from the electrical contact 72 to break an electrical connection. In a process in which the developing cartridge 100 is mounted to the drum holder 200 or the device, the movable member 94 is moved relative to the housing 1 under the action of the drum holder 200 or the inner wall of the device, and when the developing cartridge 100 is mounted to the drum holder 200 or a predetermined position on the device, the movable member 94 moves from the first position to the second position. In this case, the second contact portion 922 contacts the electrical contact 72 to implement an electrical connection. In the process, the second mounting portion 912 is always located below the second contact portion 922 and the chip 7, and the chip 7 does not experience friction and contact with the drum holder 200 or the inner wall of the device.

Specifically, in this embodiment, the movable member 94 is disposed to move relative to the housing 1 with guidance of a guide member that is pre-disposed on the housing 1/first end cover 11, and further, the chip connection assembly 9 further includes a first pushing member/restoring member 93 that is connected to/presses against the movable member 94. The restoring member 93 is configured to apply a pushing force to the movable member 94, to force the movable member 94 to have a trend of moving toward the first position. Preferably, the restoring member 93 is a plate-shaped member formed integrally with the movable member 94. In processes of mounting and removing the developing cartridge 100, the restoring member 93 is located below the second mounting portion 912, and the chip 7 and the second contact portion 922 may be further protected. Optionally, the restoring member 93 may alternatively be a compression spring or a tension spring located between the movable member 94 and the housing 1/first end cover 11.

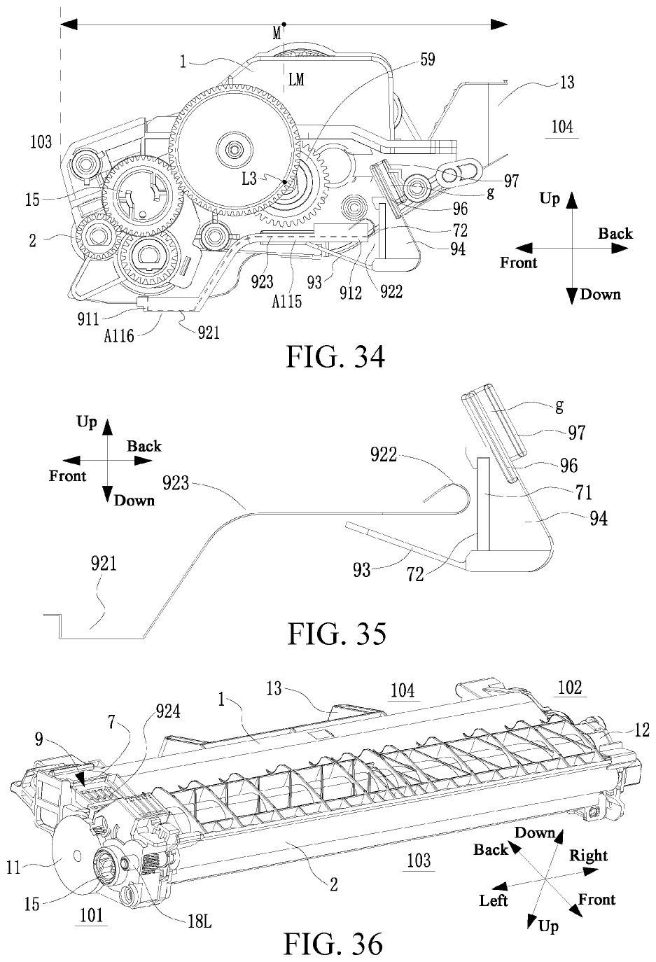

FIG. 33 is a three-dimensional diagram of an inner side of the first end cover according to Embodiment 16 of the present invention; FIG. 34 is a side view of the developing cartridge when the developing cartridge is viewed from left to right in the left-right direction after the first end cover is hidden according to Embodiment 16 of the present invention; and FIG. 35 is a schematic diagram of a relative position between the conductor and the movable member when the movable member is in a first position in the developing cartridge according to Embodiment 16 of the present invention.

In a preferred manner, the movable member 94 is guided by the guide member on the first end cover 11, and the mounting plate 91 and the conductor 92 are fixedly mounted on the first end cover 11. As shown in FIG. 33, an accommodating groove A115 and a front notch A116 and a rear notch 118 that are connected to the accommodating groove A115 are disposed on an inner side (a side facing the housing 1) of the first end cover 11, the mounting plate 91 and the conductor 92 are accommodated in the accommodating groove A115, the first contact portion 921 is exposed from the front notch A116, and the second contact portion 922 is exposed from the rear notch 118.

Further, a guide plate 117 is further disposed on the first end cover 11. Correspondingly, a guide groove g is further disposed on the movable member 94. As shown in FIG. 34, the guide groove g is formed between a front extension plate 96 and a rear extension plate 97, where the front extension plate 96 is connected to the movable member 94, preferably, the two are formed integrally, and the rear extension plate 97 is connected to the front extension plate 96. The guide groove g and the guide plate 117 are inclined relatively to the front-back direction, and the guide plate 117 gradually approaches the rear end 104 from top to bottom in the up-down direction.

As shown in FIG. 34 and FIG. 35, in the front-back direction, at least the electrical contact 72 and the driving force receiving member 15 are respectively located on two sides of the midline LM, and at least the electrical contact 72 is closer to the rear end 104 than the driving force receiving member 15, or the driving force receiving member 15 is closer to the front end 103 than the electrical contact 72. Further, at least the electrical contact 72 is located behind a rotation axis of a driving member configured to drive the stirring member to move. In the first position, the second contact portion 922 and the electrical contact 72 are separated from each other to break an electrical connection, and a free end of the restoring member 93 presses against the first end cover 11. As the developing cartridge 100 is mounted to the drum holder 200 or the device, the movable member 94 is extruded as it contacts a rear side plate 201a (as shown in FIG. 1) of the drum holder 200 or the inner wall of the device. Therefore, the movable member 94 is guided by the guide plate 117 to move toward the upper front shown in FIG. 34 until the electrical contact 72 presses against the second contact portion 922 to implement an electrical connection, and the movable member 94 reaches the second position. In addition, the free end of the restoring member 93 slides on the first end cover 11, and is deformed relative to the movable member 94 to accumulate potential energy. When the developing cartridge 100 is removed, the movable member 94 is no longer extruded, the movable member 94 moves from the second position to the first position under the action of a restoring force of the restoring member 93, and the electrical contact 72 and the second contact portion 922 are separated from each other to break the electrical connection.

Although this embodiment records that the movable member 94 moves between the first position and the second position in a sliding manner, according to the descriptions in Embodiment 12, Embodiment 13, and Embodiment 15, the movable member 94 may alternatively be disposed to rotate around a rotation axis. For a specific implementation structure, reference may be made to the descriptions in Embodiment 12, Embodiment 13, and Embodiment 15.

### Embodiment 17

FIG. 36 is a three-dimensional diagram of a developing cartridge according to Embodiment 17 of the present invention. A structure of a chip connection assembly 9 in this embodiment is different from that in the foregoing embodiments. Same components in the chip connection assembly are directly referenced, and details are not described again.

As shown in FIG. 36, the developing cartridge includes the housing 1 for accommodating toner, the developing member 2 rotatably mounted in the housing 1, the driving force receiving member 15 and the counting assembly that are located at the longitudinal end of the housing 1, and the first end cover 11 and the second end cover 12 that are connected to the housing 1. The developing member 2 is located at the front side of the housing 1, and the handle 13 is located at the rear side of the housing 1. The driving force receiving member 15 is configured to receive a driving force from the device to drive the developing member 2 and the counting assembly to operate.

An electrical connection and an electrical disconnection between the chip 7 mounted at the driving end 101 and the device are implemented by moving at least a part of the chip connection assembly 9. The at least a part of the chip connection assembly 9 is a movable member that can move between a first position and a second position. When the movable member is located in the second position, the chip 7 and the chip connection assembly 9 are electrically connected. In this case, the electrical connection can be implemented between the chip 7 and the device, and a communication connection is established between the two. When the movable member is in the first position, the electrical connection between the chip 7 and the chip connection assembly 9 is broken. In this case, the electrical connection between the chip 7 and the device is broken, and a communication connection cannot be established between the two.

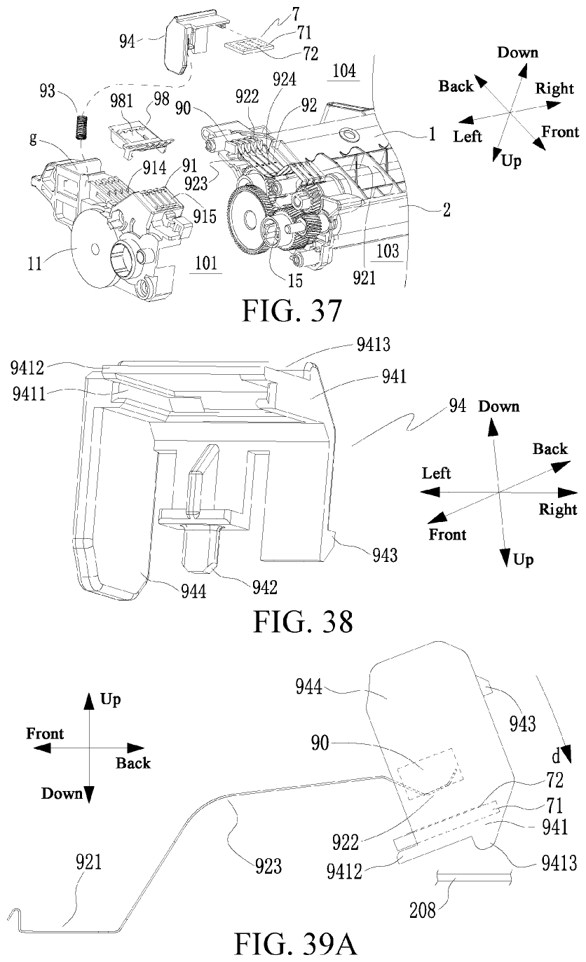

FIG. 37 is a schematic exploded view of some components of the chip connection assembly in the developing cartridge according to Embodiment 17 of the present invention; and FIG. 38 is a three-dimensional diagram of the movable member in the chip connection assembly according to Embodiment 17 of the present invention.

As in Embodiment 16, the chip 7 in this embodiment is still mounted in the movable member 94 of the chip connection assembly 9. The mounting plate 91 may be disposed on the first end cover 11 or may be disposed on the housing 1. Preferably, the mounting plate 91 is formed integrally with the first end cover 11 or the housing 1. Based on a quantity of conductors 92, a corresponding quantity of conductor mounting grooves 915 are disposed on the mounting plate 91. The restoring member 93 is a compression spring mounted between the movable member 94 and the first end cover 11/housing 1, and is configured to push the movable member 94 in a direction away from the first end cover 11/housing 1.

Further, the chip connection assembly 9 in this embodiment further includes a pressing member 98 for preventing the conductor 92 from falling off. In particular, when the conductor 92 is long and an inner surface of the conductor mounting groove 915 is non-planar, the pressing member 98 can effectively ensure that the conductor 92 is fixed to the conductor mounting groove 915 without falling off or protruding. Further, when the conductor 92 is long, the conductor 92 may be fixed to the conductor mounting groove 915 by riveting. As shown in FIG. 37, a protrusion 914 is disposed in the conductor mounting groove 915, and a through hole 924 is correspondingly disposed in the conductor 92. When the chip connection assembly 9 is assembled, the protrusion 914 passes through the through hole 924, and then an end of the protrusion 914 is heated to make the end of the protrusion larger than the through hole 924, so that the conductor 92 is fixed in the conductor mounting groove 915. Certainly, an edge of the conductor 92 may be riveted to fix the conductor 92 in the conductor mounting groove 915. For ease of the foregoing riveting operation, an operation opening 981 is disposed on the pressing member 98. Therefore, the riveting operation may be performed after the pressing member 98 is mounted, to ensure that the components of the chip connection assembly 9 are correctly mounted.

In the following, the mounting plate 91 is formed integrally with the first end cover 11, and is disposed on a surface, that faces downward, of the first end cover 11, so that the mounting of the conductor 92 becomes more convenient. In addition, a guide groove g is further disposed on the first end cover 11, and the movable member 94 is movably mounted in the guide groove g.

In this embodiment, the chip connection assembly 9 further includes a supporting member 90 that can elastically support the conductor 92, and the second contact portion 922 of the conductor 92 is supported by the supporting member 90. Specifically, based on the quantity of conductors 92, a corresponding quantity of grooves are disposed on the supporting member 90. In this way, two adjacent second contact portions 922 are separated from each other. In addition, the supporting member 90 is made of an insulating material, and a short circuit does not occur between the conductors 92. In other words, the supporting member 90 is an elastic insulator. Simplistically, the grooves may not be disposed. When the conductor 92 is fixedly mounted, under an elastic action of the supporting member 90, a position in which the supporting member contacts the second contact portion 922 is pressed and deformed to form a groove. It may be understood that when there is one conductor 92 and one electrical contact 72, the supporting member 90 may not need to be made of an insulating material.

As shown in FIG. 38, the movable member 94 includes a chip mounting body 941 and an anti-falling portion 943 and a guide plate 944 that are connected to the chip mounting body 941. One end of the compression spring 93 presses against the inside of the guide groove g, and the other end presses against a pressing portion 942 in the movable member 94. The anti-falling portion 943 is configured to prevent the movable member 94 from falling off from the guide groove g, and the guide plate 944 is movable in the guide groove g. A chip mounting groove 9411 and a top plate 9412 are disposed adjacent to each other in the chip mounting body 941. The chip 7 is mounted in the chip mounting groove 9411, and the top plate 9412 is located below the chip mounting groove 9411 in the up-down direction. Therefore, the chip 7 is separated from the baseplate 208 or the inner wall of the device by the top plate 9412. In processes of mounting and removing the developing cartridge, the chip 7 does not experience friction and contact with the baseplate 208 or the inner wall of the device.

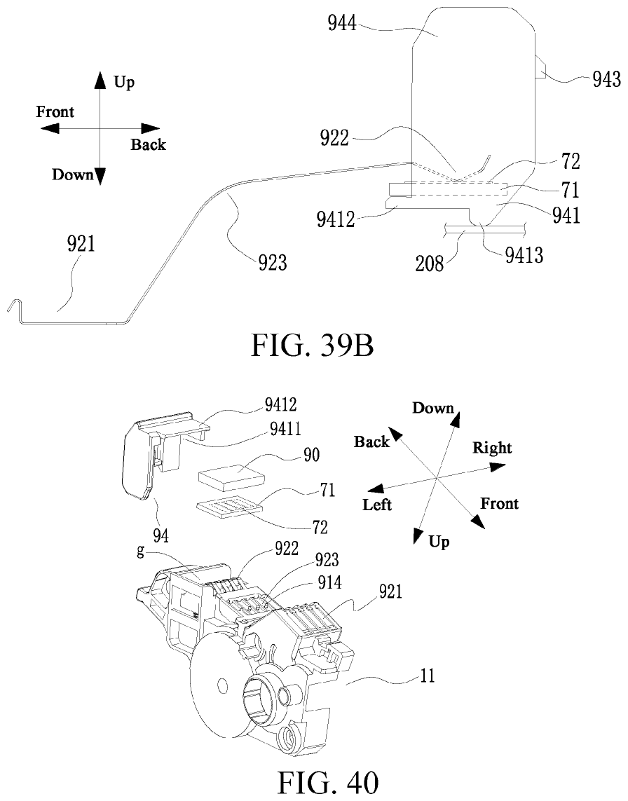

FIG. 39A is a side view of breaking, by the chip connection assembly, an electrical connection between the chip and the device when the developing cartridge is viewed from left to right before mounting according to Embodiment 17 of the present invention; and FIG. 39B is a side view of electrically connecting, by the chip connection assembly, the chip to the device when the developing cartridge is viewed from left to right before mounting according to Embodiment 17 of the present invention.

As shown in FIG. 39A, the movable member 94 is located in the first position. Under the action of gravity of the movable member 94 and an elastic force of the restoring member 93, the electrical contact 72 of the chip and the second contact portion 922 that are located in the movable member 94 are separated from each other to break an electrical connection, and the top plate 9412 is located below the chip 7. When the developing cartridge 100 is rotated around the support portion 18L/18R in a direction shown by d in the figure, the movable member 94 gradually approaches the baseplate 208 or the inner wall of the device.

Relative to the baseplate 208/inner wall of the device, a moving track of the movable member 94 in the direction shown by d is an arc line. To ensure force balance of the top plate 9412/movable member 94, preferably, the movable member 94 further includes a pre-stressed portion 9413 disposed below the top plate 9412. With rotation of the developing cartridge 100, both the pre-stressed portion 9413 and the top plate 9412 that is inclined relative to the baseplate 208/inner wall of the device contact the baseplate 208/inner wall of the device. Therefore, a pressure force applied on the movable member 94 by the baseplate 208/inner wall of the device is more balanced, until the movable member 94 reaches a second position shown in FIG. 39B. In this case, the electrical contact 72 of the chip contacts the second contact portion 922. It should be noted that when the pre-stressed portion 9413 is not disposed and the movable member 94 is located in the second position shown in FIG. 39B, a lower surface of the top plate 9412 presses against the baseplate 208/inner wall of the device.

### Embodiment 18

FIG. 40 is a schematic exploded view of some components of a chip connection assembly in a developing cartridge according to Embodiment 18 of the present invention.

Different from Embodiment 17, in this embodiment, the supporting member 90 is disposed on the movable member 94, contacts the chip 7, and no longer contacts the conductor 92. As shown in the figure, the supporting member 90 made of an elastic non-conductive material is located below the chip 7. Specifically, the supporting member 90 is located between the chip 7 and the top plate 9412, and this arrangement can also ensure good contact between the chip 7 and the second contact portion 922.

According to the foregoing description, disposing the supporting member 90 in a position adjacent to at least one of the chip 7 and the second contact portion 922 can ensure good contact between the chip 7 and the second contact portion 922. The supporting member 90 supports at least one of the chip 7 and the second contact portion 922 in a direction in which the chip 7 and the second contact portion 922 approach each other. Further, the arrangement of the supporting member 90 further has the following beneficial effects:

Both the chip connection assembly 9 and the chip 7 are located at the driving end 101 of the developing cartridge 100. Therefore, when vibration generated when the driving force receiving member 15 works is transmitted to the chip 7, the supporting member 90 can effectively counteract the vibration.

Regardless of whether the supporting member 90 is disposed to support the second contact portion 922 of the conductor or support the chip 7, in a process in which the chip 7 contacts the second contact portion 922, the chip 7 or the second contact portion 922 may adaptively adjust a position, so that a contact area between the chip 7 and the second contact portion 922 is larger.

When the developing cartridge 100 is mounted to the drum holder 200 or the device, a large instantaneous acting force is generated between the chip 7 and the second contact portion 922 once a mounting speed of the developing cartridge 100 is too fast, and a part of the acting force may be absorbed by the elastic supporting member 90, so that the chip 7 and the second contact portion 922 are in smooth contact.

As described above, the movable member 94 reaches the second position from the first position by pressing against the baseplate 208 or the inner wall of the device. Baseplates 208 of drum holders of different models and inner walls of devices of different models may have different structures, and correspondingly, a same movable member 94 is subjected to different acting forces. The arrangement of the supporting member 90 reduces a stroke of the movable member 94 from the first position to the second position. Even if an acting force exerted on the movable member 94 is too small, the chip 7 can be in good contact with the second contact portion 922. From another point of view, when an acting force exerted on the movable member 94 is too large, the supporting member 90 can absorb a part of the acting force, so that the chip 7 and the second contact portion 922 keep in good contact, to prevent rigid contact from forming between the chip 7 and the second contact portion 922 and prevent the chip 7 from being damaged. Therefore, the movable member 94 on which the supporting member 90 is disposed may be applicable to different types of developing cartridges.

It should be noted that, in the figure, the first contact portion 921, the second contact portion 922, and the electrical contact 72 have specific sizes in both the front-back direction and the left-right direction. However, the first contact portion 921, the second contact portion 922, and the electrical contact 72 are not limited by the sizes.

As described above, in the developing cartridge 100 in the present invention, in the front-back direction, at least the electrical contact 72 in the chip 7 is fixedly mounted in a position away from the driving force receiving member 15, and the chip 7 may establish a communication connection to the device by using the chip connection assembly 9 of which at least a part is movable relative to the housing 1. On the one hand, when the developing cartridge works, impact of vibration of the driving force receiving member 15 on the electrical contact 72 is reduced. On the other hand, in processes of mounting and removing the developing cartridge 100, the electrical contact 72 does not experience friction and contact with the drum holder 200 or the inner wall of the device, thereby avoiding a problem that the chip 7 lacks electrical conductivity, is short-circuited, or falls off from the developing cartridge.

### Embodiment 19

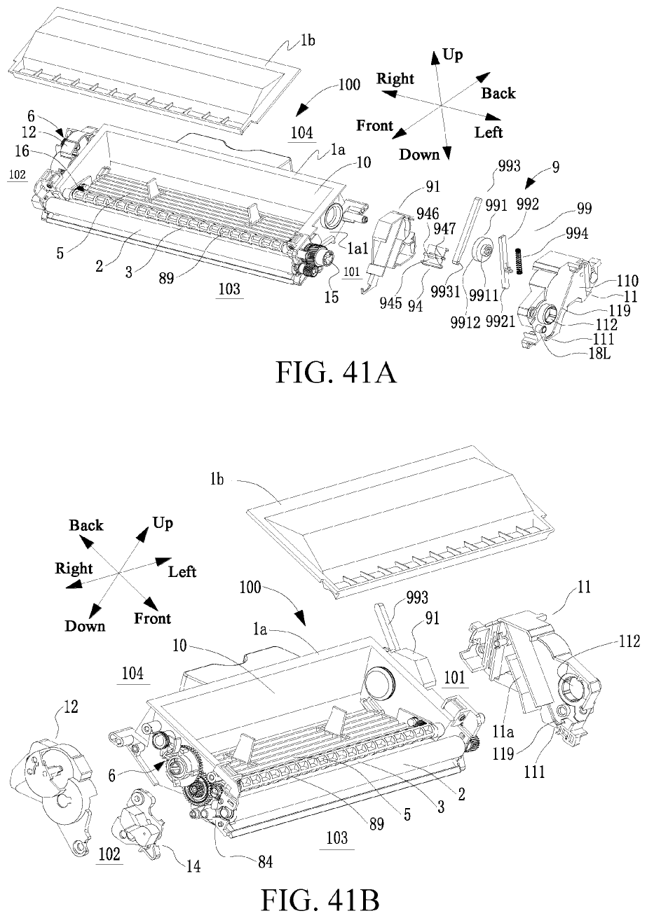

FIG. 41A is a schematic exploded view of a chip connection assembly and a housing after the chip connection assembly and the housing are separated in a developing cartridge according to Embodiment 19 of the present invention; and FIG. 41B is a schematic exploded view of the housing and some components of an end at which no chip connection assembly is mounted in the developing cartridge according to Embodiment 19 of the present invention.

The housing 1 includes a bottom housing 1a and a top cover 1b that are combined with each other, and a toner accommodating cavity 10 is formed between the bottom housing 1a and the top cover 1b. The developing cartridge 100 further includes a toner conveying member 3 and a driving member 89 that are rotatably mounted in the housing 1, a stirring member 5 that can reciprocate in the front-back direction in the toner accommodating cavity 10, and a counting assembly 6, where the driving member 89 is disposed coaxially with a driving force receiving member 15, a cam is disposed on the driving member 89, and an elastic member 16 is connected to the cam and the stirring member 5. With rotation of the driving member 89, the stirring member 5 reciprocates in the front-back direction under an elastic action of the elastic member 16. When the counting assembly 6 and the driving force receiving member 15 are respectively located on two sides of the housing 1, the developing cartridge further includes a middle member 84 disposed on the same side as the counting assembly 6. Preferably, the middle member 84 is combined with the driving member 89, that is, the middle member 84 and the driving force receiving member 15 are respectively located on two sides of the driving member 89. When the driving member 89 rotates, a driving force is transmitted to the counting assembly 6 through the middle member.

As shown in FIG. 41A, in this embodiment, the chip connection assembly 9 and the driving force receiving member 15 are disposed on a same side. In this way, in the left-right direction of the developing cartridge, the chip connection assembly 9 and the counting assembly 6 are respectively located on the left side and the right side of the housing 1, and there is enough space on the left side of the developing cartridge to dispose the chip connection assembly 9. Certainly, when there is enough space on the left side of the developing cartridge to accommodate the chip connection assembly 9 and the counting assembly 6, the chip connection assembly 9 and the counting assembly 6 may be disposed on a same side of the housing at the same time. In this case, the middle member 84 and a component located between the middle member 84 and the counting assembly 6 may also be canceled.

The chip connection assembly 9 includes a mounting plate 91, a movable member 94, and an acting force transmitting mechanism 99. The movable member 94 and the acting force transmitting mechanism 99 are located between the mounting plate 91 and a first end cover 11, the mounting plate 91 is fixedly mounted on a left side plate 1a1 of the housing, and a part of the acting force transmitting mechanism 99 is located on the mounting plate 91. The movable member 94 is configured to accommodate all or a part of a chip 7, and at least an electrical contact 72 of the chip 7 is accommodated in the movable member 94. The acting force transmitting mechanism 99 is combined with the movable member 94 and is configured to transmit a received external acting force to the movable member 94, so that the movable member 94 moves between a first position and a second position. In the first position, an electrical connection between the electrical contact 72 and a device is broken, and in this case, the electrical contact 72 is not located in an electrical connection area 111 of the first end cover 11. In the second position, the electrical contact 72 can be electrically connected to the device, and the electrical contact 72 is located in the electrical connection area 111 of the first end cover 11.

In practice, the mounting plate 91 may be omitted. In this case, the movable member 94 and the acting force transmitting mechanism 99 are located between the left side plate 1a1 of the housing and the first end cover 11, and the acting force transmitting mechanism 99 may be mounted on the left side plate 1a1 of the housing, or may be mounted on the first end cover 11.

In this embodiment, the acting force transmitting mechanism 99 includes a transmitting member 991 and a driving rod 992 and a driven rod 993 that are combined with the transmitting member 991. The movable member 94 is combined with the driven rod 993. In a process in which the developing cartridge 100 is mounted to a drum holder 200 or the device, the driving rod 992 receives a driving force from outside, and the transmitting member 991 transmits the driving force to the driven rod 993. Further, the acting force transmitting mechanism 99 further includes a restoring member 994. When the developing cartridge 100 is removed from the drum holder 200 or the device, under the action of the restoring member 994, the acting force transmitting mechanism 99 returns to an initial state before the developing cartridge 100 is mounted. The movable member 94 can move from the first position to the second position, and can return to the first position from the second position under the action of the restoring member 994.

Specifically, gear teeth are disposed on both the driving rod 992 and the driven rod 993, and the transmitting member 991 is disposed as a gear. The gear teeth are meshed with the gear, to transmit an acting force from the driving rod 992 to the driven rod 993. An end of the driving rod 992 is disposed as a trigger end 9921 configured to receive the acting force, and a combining portion 9931 for combining with the movable member 94 is disposed on the driven rod 993. Preferably, the driven rod 993 is movably connected to the movable member 94 through a rotating shaft, and in this case, the movable member 94 can freely sway on the driven rod. The transmitting member 991 is disposed as a dual gear and has a pinion portion 9911 and a gearwheel portion 9912. The pinion portion 9911 is meshed with the driving rod 992, and the gearwheel portion 9912 is meshed with the driven rod 993. In this case, the acting force transmitting mechanism 99 is formed as a stroke amplifying mechanism, to be specific, the driving rod 992 moves for a small stroke, and the driven rod 993 can move for a large stroke through the transmitting member 991. This structure is applicable to the developing cartridge 100 with limited internal space on the drum holder 200 or the device. The restoring member 994 may press against both the driving rod 992 and the driven rod 993, and when the trigger end 9921 no longer receives the acting force, it only needs that the restoring member 994 can restore the acting force transmitting mechanism 99 or the restoring member 994 can make the movable member 94 return to the first position from the second position.

The gearwheel portion 9912 and the pinion portion 9911 each may alternatively be replaced with a disk-like body on which a rubber ring is sleeved in a circumferential direction. Similarly, a part of the driving rod 992, which is combined with the pinion portion 9911, may alternatively be replaced with a friction surface that can transmit a driving force, and a part of the driven rod 993, which is combined with the gearwheel portion 9912, may alternatively be replaced with a friction surface that can transmit a driving force. Therefore, the transmitting member 991 may be summarized as a rotation body that has a large-diameter portion 9912 and a small-diameter portion 9911.

The movable member 94 includes a main body 945 and a combined portion 946 and a guide protrusion 947 that are located on the main body 945. At least the electrical contact 72 of the chip 7 is located on the main body 945. The combining portion 9931 and the combined portion 946 are movably combined. When the driven rod 993 moves, the guide protrusion 947 guides the main body 945, to ensure that at least the electrical contact 72 can reach the second position with the main body 945.

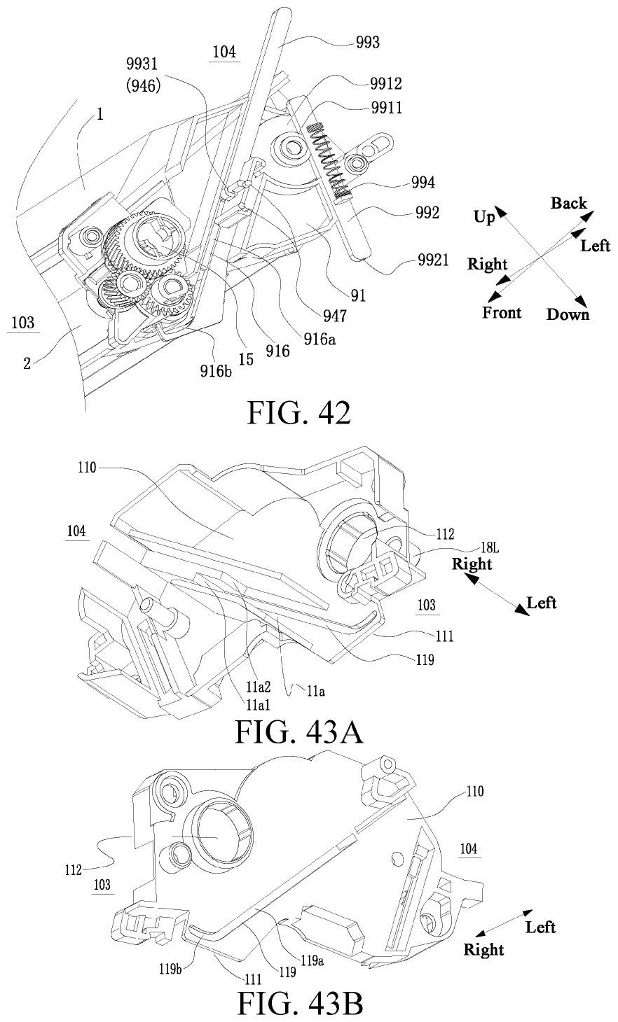

FIG. 42 is a three-dimensional diagram of the chip connection assembly after the chip connection assembly is mounted to the housing in the developing cartridge according to Embodiment 19 of the present invention; and FIG. 43A and FIG. 43B are three-dimensional diagrams of the first end cover in the developing cartridge according to Embodiment 19 of the present invention.

The mounting plate 91 is fixedly mounted on the housing 1, and the transmitting member 991 is rotatably mounted on the mounting plate 91. In addition, a limiting groove 916 is also disposed on the mounting plate 91, and the limiting groove 916 extends, in a moving direction of the driven rod 993, from the upper side of the mounting plate to a position corresponding to the electrical connection area 111, and has a first section 916a inclined relative to the front-back direction and a second section 916b parallel to the front-back direction. The first section 916a is connected to the second section 916b, and the guide protrusion 947 is located in the limiting groove 916. When the mounting plate 91 is not disposed, the transmitting member 991 may be directly mounted on the housing 1, and the limiting groove 916 is also disposed on the housing 1.

The combining portion 9931 of the driven rod is combined with the combined portion 946 of the movable member 94. Under the limitation of the limiting groove 916 and the guide protrusion 947, the main body 945 is basically parallel to the driven rod 993, and resistance on the driven rod 993 in a moving process may be reduced. The restoring member 994 is preferably a compression spring, one end of which presses against the driving rod 992, and the other end of which presses against the first end cover 11, and both the driving rod 992 and the driven rod 993 remain stationary under a holding action of the restoring member 994.

As shown in FIG. 43A and FIG. 43B, the first end cover 11 includes an end cover body 110, a through hole 112 and a guide groove 119 that are disposed in the end cover body 110, and a sliding groove 11a that at least partially overlaps the guide groove 119. The driving force receiving member 15 is exposed through the through hole 112. A shape of the guide groove 119 corresponds to the limiting groove 916, that is, the guide groove 119 extends, in the moving direction of the driven rod 993, from the upper side of the first end cover 11 to the electrical connection area 111. Therefore, the guide groove 119 also has a first section 119a inclined relative to the front-back direction and a second section 119b parallel to the front-back direction, and the first section 119a is connected to the second section 119b. The guide protrusion 947 disposed on the movable member 94 is further combined with the guide groove 119. In a preferred solution, the guide groove 119 may be disposed to penetrate the end cover body 110 in the left-right direction. In this way, a specific position of the guide protrusion 947 in the guide groove 119 may be viewed from outside of the developing cartridge, which helps improve user experience of an end user. Alternatively, the guide groove 119 may be disposed not to penetrate the end cover body 110 in the left-right direction, or on the premise that the guide groove 119 does not penetrate the end cover body 110 in the left-right direction, the end cover body corresponding to the guide groove 119 is disposed to be transparent, so that the position of the guide protrusion 947 can also be viewed from the outside of the developing cartridge.

Further, the first end cover 11 further includes a first limiting portion 11a1 and a second limiting portion 11a2 that are disposed in the sliding groove 11a. When the driven rod 993 is mounted to the sliding groove 11a, the main body 945 of the movable member is limited by pressing against the first limiting portion 11a1, and the combined portion 946 is limited by pressing against the second limiting portion 11a2. Therefore, a relative position between the movable member 94 and the driven rod 993 keeps stable.

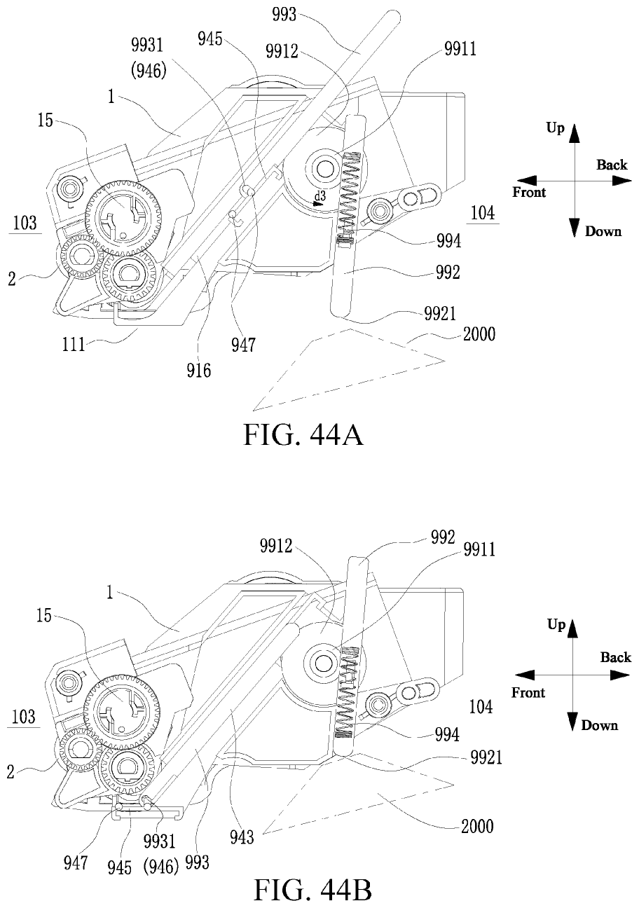

FIG. 44A is a schematic diagram of a state of the chip connection assembly before the chip connection assembly is triggered in the developing cartridge according to Embodiment 19 of the present invention; and FIG. 44B is a schematic diagram of a state of the chip connection assembly after the chip connection assembly is triggered in the developing cartridge according to Embodiment 19 of the present invention.

To clearly see a movement process of the acting force transmitting mechanism 99, the first end cover 11 is hidden in FIG. 44A and FIG. 44B. Before the developing cartridge 100 is mounted, the electrical contact 72 is in the first position with the movable member 94. As shown in FIG. 44A, the movable member 94 is located in the first section 916a of the limiting groove 916/the first section 119a of the guide groove 119. In the front-back direction, the movable member 94 is located on the rear side of the driving force receiving member 15, and in the up-down direction, the movable member 94 does not go beyond the housing 1, and the main body 945 of the movable member is substantially parallel to the driven rod 993. In this case, even if the developing cartridge is impacted by an external force, the electrical contact 72 is not damaged.

As the developing cartridge 100 rotates downward around the support portion 18L/18R, the trigger end 9921 starts to press against a pressing portion 2000 outside the developing cartridge 100, the driving rod 992 starts to move upward, the restoring member 994 is elastically deformed, the dual gear 991 rotates in a direction shown by d3, the driven rod 993 slides in the sliding groove 11a and drives the movable member 94 to move along the limiting groove 916 toward the electrical connection area 111. As shown in FIG. 44B, after the developing cartridge 100 is mounted to a predetermined position, the driving rod 992 stops moving upward, and the driven rod 993 stops moving. In this case, the movable member 94 starts to enter the second section 916b of the limiting groove 916/the second section 119b of the guide groove 119. Because the movable member 94 is movably connected to the driven rod 993, the movable member 94 rotates around the combined portion 946 under the gravity of the movable member 94 to reach the second position, and the guide protrusion 947 completely enters the second section 916b of the limiting groove 916/the second section 119b of the guide groove 119. The main body 945 of the movable member is basically parallel to the front-back direction, and the electrical contact 72 faces downward.

When the developing cartridge 100 is removed from the drum holder 200 or the device, the trigger end 9921 is separated from the pressing portion 2000, and under the action of a restoring force of the restoring member 994, the driving rod 992 moves downward, the transmitting member 991 rotates in a direction opposite to the direction shown by d3, and the driven rod 993 drives the movable member 94 to move from the second section 916b of the limiting groove 916/the second section 119b of the guide groove 119 to the first section 916a/119a, until the movable member 94 returns to the first position.

### Embodiment 20

FIG. 45 is a schematic diagram of states of a chip connection assembly before and after the chip connection assembly is triggered in a developing cartridge according to Embodiment 20 of the present invention.

In this embodiment, the movable member 94 is still guided by the guide groove 119 located on at least the first end cover 11 to move between the first position and the second position. A difference lies in that in this embodiment, the structure of the acting force transmitting mechanism 99 is simplified. As shown in FIG. 45, the acting force transmitting mechanism 99 is a rotating rod 995 that rotates around a rotating shaft, the rotating rod 995 has a rod body 9953, a first end 9951 of the rod body 9953 forms a trigger end, a second end/combining portion 9952 of the rod body 9953 is movably connected to the movable member 94, and a connection manner between the two is the same as that in Embodiment 19. In addition, at least the electrical contact 72 of the chip 7 is located in the movable member 94, and may move with movement of the movable member 94.

The rotating rod 995 further has a rotating portion 9954. Preferably, the rotating rod 995 is separated by the rotating portion 9954 as a hard lever based on the trigger end 9951. Therefore, the rotating rod 995 also forms a stroke amplifying mechanism, in other words, when the trigger end 9951 receives an acting force and causes the rotating rod 995 to rotate around the rotating portion 9954, a stroke of the second end 9952 is greater than a stroke of the first end/trigger end 9951.

Similarly, before the developing cartridge 100 is mounted, as shown by dotted lines in the figure, the movable member 94 is located at a same first position as in Embodiment 19. As the developing cartridge 100 is mounted to the drum holder 200 or the device and rotates downward around the support portion 18L/18R, the trigger end 9951 contacts the pressing portion 2000, and further, the rotating rod 995 rotates around the rotating portion 9954 in a direction shown by d4 until the movable member 94 reaches the second position, as shown by solid lines in the figure.

As not shown in FIG. 45, the acting force transmitting mechanism 99 in this embodiment further includes a restoring member that is combined with the rotating rod 995. In a process in which the movable member 94 moves from the first position to the second position, the restoring member is elastically deformed. When the trigger end 9951 is separated from the pressing portion 2000, under the action of a restoring force of the restoring member, the rotating rod 995 rotates in a direction opposite to the direction shown by d4, and the movable member 94 returns from the second position to the first position.

For Embodiment 19 and Embodiment 20, a combination position between the combining portion 9931/9952 in the acting force transmitting mechanism 99 and the combined portion 946 on the movable member may be changed based on a contact position between the power terminal in the device and the electrical contact 72 of the chip. For example, in the front-back direction, when the contact position between the power terminal and the electrical contact 72 of the chip is approximately located in the middle of the main body 945 of the movable member, the combination position between the combining portion 9931/9952 and the combined portion 946 is located in the approximately middle of the main body 945 of the movable member, which is conducive to keeping overall stability of the movable member 94. In the front-back direction, when the contact position between the power terminal and the electrical contact 72 of the chip is approximately located at the front side of the middle of the main body 945 of the movable member, according to a lever principle, the combination position between the combining portion 9931/9952 and the combined portion 946 is located at the rear side of the approximately middle of the main body 945 of the movable member, which is conductive to keeping the overall stability of the movable member 94. On the contrary, in the front-back direction, when the contact position between the power terminal and the electrical contact 72 of the chip is approximately located at the rear side of the middle of the main body 945 of the movable member, the combination position between the combining portion 9931/9952 and the combined portion 946 is located at the front side of the approximately middle of the main body 945 of the movable member, which is conductive to keeping the overall stability of the movable member 94.

Certainly, when space in the developing cartridge 100 is sufficient, a combination position between the acting force transmitting mechanism 99 and the movable member 94 may be further disposed as two positions distributed in the front-back direction, so that the movable member 94 has two support points when the movable member 94 is in the second position. In this way, even if the contact position between the power terminal and the electrical contact 72 of the chip is not in the approximately middle of the main body 945 of the movable member, the movable member 94 can still keep the overall stability.

According to the inventive concept of the present invention, the movable mounting plate 91 in the foregoing Embodiment 12 to Embodiment 15 and the movable member 94 in Embodiment 16 to Embodiment 18 may be considered as all or a part of the acting force transmitting mechanism 99. In Embodiment 16 to Embodiment 18, the chip 7/electrical contact 72 moves between the first position and the second position with movement of the movable member 94. Therefore, the movable member 94 in Embodiment 16 to Embodiment 18 is similar to the movable member 94 in Embodiment 19 and Embodiment 20, and serves to support at least the electrical contact 72 of the chip. In Embodiment 12 to Embodiment 15, the electrical contact 72 is not moved, and the chip 7 is electrically connected to and electrically disconnected from the power terminal through movement of the conductor 92. In this case, the conductor 92 may be considered as an extension of the electrical contact 72. As the mounting plate 91 is moved, the conductor 92 and the power terminal switch between electrical connection and electrical disconnection.

The “electrical connection” means that communication can be performed between the electrical contact 72 and the power terminal. The “electrical disconnection” means that communication cannot be performed between the electrical contact 72 and the power terminal. It may be understood by a person skilled in the art that, the communication between the electrical contact 72 and the power terminal may be implemented by enabling the electrical contact 72 and the power terminal to directly contact each other or enabling the electrical contact 72 and the power terminal not to contact each other, for example, wireless communication is used between the two, specifically, the wireless communication is near field communication (NFC), Bluetooth communication, or the like.

In conclusion, the acting force transmitting mechanism 99 in the present invention causes the movable member 94 to drive at least the electrical contact 72 of the chip 7 to move between the first position and the second position. In the first position, the electrical connection between the electrical contact 72 and the power terminal in the device is broken, and in the second position, the electrical contact 72 can be electrically connected to the power terminal in the device. It may be understood that, an acting force during movement of the acting force transmitting mechanism 99 is generated by pressing the mounting plate 91 or the movable member 94, or generated in a contactless manner. For example, a magnet is mounted on the mounting plate 91 or the movable member 94, and correspondingly, another magnet is mounted on the drum holder 200 or the inner wall of the device, and a magnetic force between the two magnets is used to force the mounting plate 91 or the movable member 94 to move. Alternatively, an electromagnet is mounted on the mounting plate 91 or the movable member 94, and after the developing cartridge 100 is mounted to the drum holder 200 or the device, the electromagnet is triggered for connection, to generate a magnetic force that forces the mounting plate 91 or the movable member 94 to move.

As described above, when the developing cartridge 100 works, the chip 7/electrical contact 72 is located at the bottom of the housing 1, and this causes that an operator cannot view the chip 7/electrical contact 72 in processes of mounting and removing the developing cartridge 100. In this case, the chip 7/electrical contact 72 easily experiences friction and contact with the drum holder 200, the inner wall of the device, or an external component of the device, causing damage to the chip 7/electrical contact 72. In the foregoing embodiment of the present invention, before the developing cartridge 100 is mounted, the chip 7/electrical contact 72 is no longer located at the bottom of the housing 1 in the up-down direction, thereby effectively preventing damage to the chip 7/electrical contact 72 in the processes of mounting and removing the developing cartridge 100. In the given embodiment, before the developing cartridge 100 is mounted, the chip 7/electrical contact 72 is located in a middle position of the housing in the up-down direction. In this case, the chip 7/electrical contact 72 is protected by the housing 1 or/and the first end cover 11, and a probability that the chip 7/electrical contact 72 experiences friction and contact with the drum holder 200, the inner wall of the device, or the external component of the device may be further reduced.

### Embodiment 21

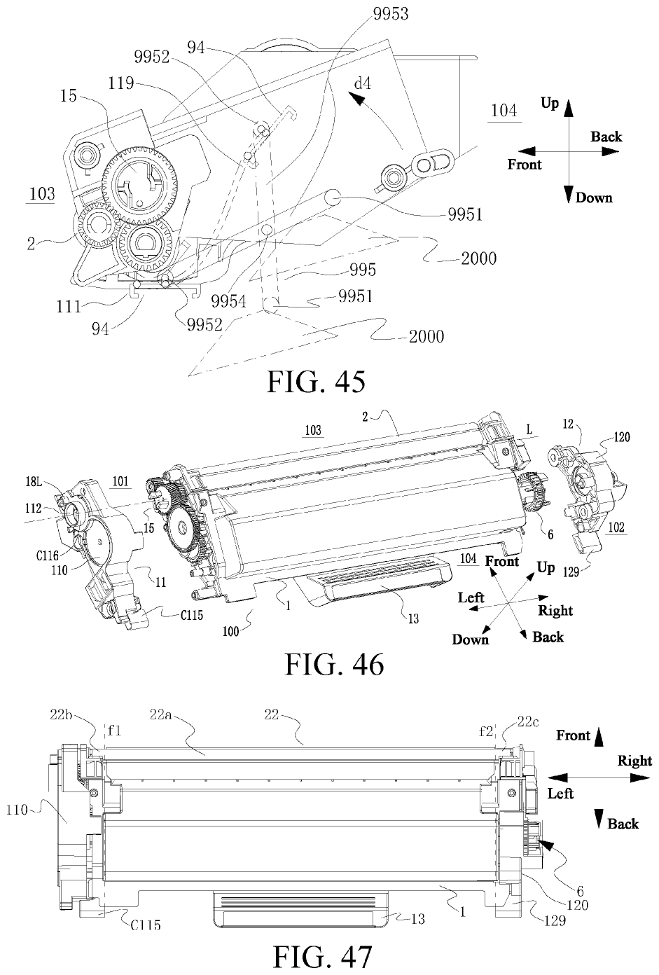

FIG. 46 is a schematic exploded view of a developing cartridge after two end covers are separated from a housing according to Embodiment 21 of the present invention; and FIG. 47 is a top view of the developing cartridge when the developing cartridge is viewed from top to bottom in an up-down direction according to Embodiment 21 of the present invention.

As shown in FIG. 1, the developing member 2 includes a rotation shaft 21 and an clastic conductive member 22 that is coated on the circumferential surface of the rotation shaft. When the developing cartridge 100 is mounted to the drum holder 200, the developing member 2/elastic conductive member 22 is opposite to the photosensitive drum 203. Preferably, the developing member 2 directly contacts the photosensitive drum 203 and keeps the contact state, which is most beneficial to improving an imaging effect of the device. Therefore, as shown in FIG. 46 and FIG. 47, the developing cartridge 100 further includes stressed portions configured to receive a pushing force, and two stressed portions are respectively located at two ends of the developing cartridge 100 in the left-right direction. Correspondingly, the drum holder 200 has a pushing portion (not shown) configured to push the stressed portions. Specifically, one of the two stressed portions is disposed on a driving end cover 11, and the other is disposed on the conductive end cover 12. As shown in FIG. 46, the driving end cover 11 includes a first main body 110, a through hole 112 that passes through the first main body in the left-right direction, a neck portion C116 that is disposed in a circumferential direction of the through hole 112, and a first protrusion C115 that protrudes from the first main body 110. The driving force receiving member 15 is exposed from the through hole 112, and the first protrusion C115 extends backward and rightward from the first main body 110. When the driving end cover 11 is mounted to the housing 1, a part of the driving force receiving member 15 is surrounded by the neck portion C116. The conductive end cover 12 includes a second main body 120 and a second protrusion 129 disposed on the second main body. The second protrusion 129 extends backward and leftward from the second main body 120, and the handle 13 is located between the first protrusion C115 and the second protrusion 129 in the left-right direction.

For the driving end cover 11, the housing 1 is located on the right side of the driving end cover 11, and for the conductive end cover 12, the housing 1 is located on the left side of the conductive end cover 12. Therefore, the first protrusion C115 and the second protrusion 129 may be described as protruding backward from the main bodies of the end covers in which the first protrusion C115 and the second protrusion 129 are respectively located, and simultaneously protruding in a direction close to the housing 1. As shown in FIG. 46, a volume of the driving end cover 11 and a volume of the conductive end cover 12 are far less than a volume of the housing 1 relative to a size of the housing 1 in the left-right direction. Therefore, even if the first protrusion C115 is disposed on the driving end cover 11 and the second protrusion 129 is disposed on the conductive end cover 12, compared with the housing 1, the driving end cover 11 and the conductive end cover 12 are not easily broken in a transportation process. On the other hand, a size of the housing 1 in the front-back direction is reduced, which is conductive to reducing precision of a mold for manufacturing the housing 1.

FIG. 47 is a top view of the developing cartridge when the developing cartridge is viewed from top to bottom in the up-down direction according to the present invention.

When the developing cartridge 100 is assembled and viewed in the up-down direction, both the first protrusion C115 and the second protrusion 129 overlap a part of the developing member 2 in the left-right direction. As shown in FIG. 47, in a direction parallel to the front-back direction, straight lines f1 and f2 are respectively drawn on the rightmost side of the first protrusion C115 and the leftmost side of the second protrusion 129. Both the straight lines f1 and f2 pass through the elastic conductive member 22. That is, in the left-right direction, both the first protrusion C115 and the second protrusion 129 partially overlap the clastic conductive member 22 of the developing member 2. As shown in the figure, an elastic conductive member 22b located on the left side of the straight line f1 and an elastic conductive member 22c located on the right side of the straight line f2 each are a non-imaging area, and an elastic conductive member 22a located between the straight line f1 and the straight line f2 is an imaging area. Therefore, when the first protrusion C115 and the second protrusion 129 are subjected to a forward pushing force, the middle of the developing member 2 is less forced than the left end and the right end, which is conductive to reducing the load when the photosensitive drum 203 and the developing member 2 rotate relatively.

### Embodiment 22

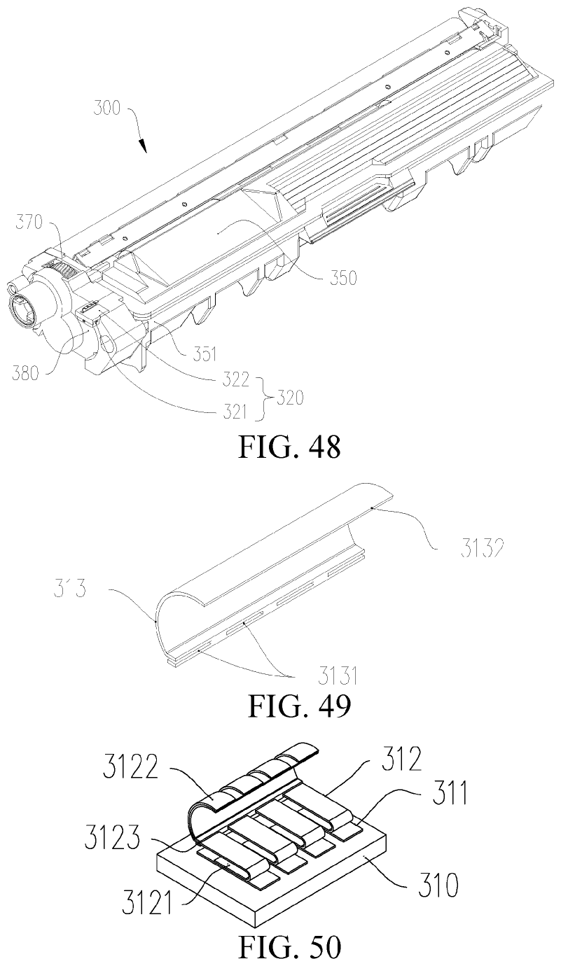

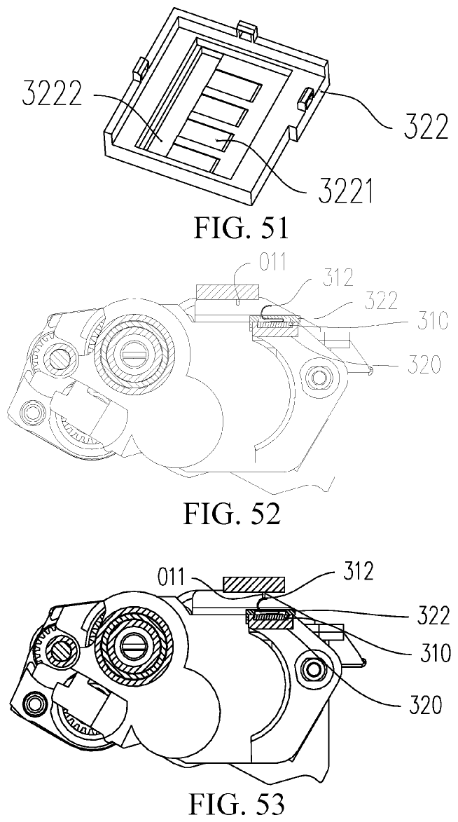

FIG. 48 is a three-dimensional schematic diagram of a developing cartridge according to Embodiment 22 of the present invention; FIG. 49 is a three-dimensional schematic diagram of an auxiliary frame in the developing cartridge according to Embodiment 22 of the present invention; FIG. 50 is a three-dimensional schematic diagram of a combination of a memory and an electrical contact of the memory in the developing cartridge according to Embodiment 22 of the present invention; FIG. 51 is a schematic diagram of a memory protective cover in the developing cartridge according to Embodiment 22 of the present invention; FIG. 52 is a schematic diagram of an electrical connection section when the developing cartridge is not completely mounted in a printer according to Embodiment 22 of the present invention; FIG. 53 is a schematic diagram of an electrical connection section when the developing cartridge is completely mounted in the printer according to Embodiment 22 of the present invention.

As shown in FIG. 48 to FIG. 53, the developing cartridge 300 includes a driving assembly 370, an end cover 380, and a bin 350 serving as a developer storage portion. The end cover 380 is located at a first end 351 of the bin 350, the driving assembly 370 is located between the bin 350 and the end cover 380, and the driving assembly 370 is configured to receive and transmit power from a printer.

A holder 320 is configured to accommodate and mount the memory 310. The holder 320 includes a lower base 321 and an upper cover 322. In another embodiment, the upper cover 322 is not limited to being fixed to the lower base 321 in a fastening manner, and may be fixed by welding or bonding. Preferably, the holder 320 is formed on the end cover 380.

The memory 310 is mounted between the lower base 321 and the upper cover 322, and an electrical contact 311 of the memory 310 is disposed on the upper side of the memory 310.

An electrical contact sheet 312 is disposed on the upper side of the electrical contact 311, and a lower end 3121 of the electrical contact sheet 312 is electrically connected to the electrical contact 311. An upper end 3122 of the electrical contact sheet 312 is configured to be electrically connected to an electrical contact 011 of the printer. Preferably, a middle portion 3123 of the electrical contact sheet 312 passes through a fastening hole 3131 of the auxiliary frame 313, and four electrical contact sheets 312 perform auxiliary positioning by using the auxiliary frame 313, to maintain that relative positions of the electrical contact sheets 312 are not easily changed. A support portion 3132 that sticks close to the upper end 3122 of the electrical contact sheet 312 is formed on the upper side of the auxiliary frame 313, and the support portion 3132 provides elastic support for the electrical contact sheet 312, which is conductive to improving fatigue resistance of the S-shaped electrical contact sheet 312.

Preferably, the electrical contact sheet 312 is disposed to be S-shaped. In this way, the electrical contact sheet 312 may be elastically deformed when subjected to an external force.

Preferably, a trench 3221 corresponding to the middle portion 3123 of the S-shaped electrical contact sheet 312 is formed on the upper cover 322. A through hole 3222 is formed on the upper side of the upper cover 322, and the upper end 3122 of the S-shaped electrical contact sheet 312 penetrates upward through the through hole 3222 and is electrically connected to the electrical contact 011 of the printer.

When the developing cartridge 300 is mounted into the printer, the upper end 3122 of the S-shaped electrical contact sheet 312 contacts the electrical contact 011 of the printer, and the S-shaped electrical contact sheet 312 is elastically deformed, so that a predetermined contact pressure is formed between the upper end 3122 and the electrical contact 011, thereby improving electrical connection reliability. The electrical contact 311 of the memory 310 is electrically connected to the electrical contact 011 of the printer through the S-shaped electrical contact sheet 312.

It can be learned that the S-shaped electrical contact sheet 312 may be considered as a movable member in a chip connection assembly in this embodiment. Before the developing cartridge 300 is mounted to the printer, the S-shaped electrical contact sheet 312 is in a first position. In this case, the lower end 3121 of the electrical contact sheet is electrically connected to the electrical contact 311, but an electrical connection between the upper end 3122 of the electrical contact sheet and the device (the electrical contact 011 of the printer) is broken and then a communication connection cannot be established between the two. As the developing cartridge 300 is mounted, the S-shaped electrical contact sheet 312 is elastically deformed to move from the first position to a second position. In the second position, the upper end 3122 of the electrical contact sheet is electrically connected to the device, and then a communication connection is established between the electrical contact 311 and the device. The S-shaped electrical contact sheet 312 avoids, through elastic deformation, a case in which the developing cartridge cannot be smoothly mounted due to interference from the S-shaped electrical contact sheet 312 and the printer in a process of mounting the developing cartridge to the printer, and also avoids a case in which the S-shaped electrical contact sheet 312 is in rigid contact with another component to generate a greater contact friction force. Even if the S-shaped electrical contact sheet 312 contacts another component, the S-shaped electrical contact sheet 312 can be deformed based on a contact pressure, thereby improving mounting flexibility of the developing cartridge 300.

There is no need to dispose a linkage member between the developing cartridge 100 and a door cover of the printer, thereby simplifying a structure, improving electrical connection reliability, and reducing manufacturing difficulty and production costs.

What is claimed is:

1. A developing cartridge, detachably mounted in a device, wherein the developing cartridge comprises a housing, a chip, a developing member rotatably mounted in the housing, and a driving force receiving member located at a longitudinal end of the housing;
the driving force receiving member is configured to receive a driving force from an outside of the developing cartridge to drive the developing member to rotate; and the chip is provided with an electrical contact;
the developing cartridge further comprises a chip connection assembly, and at least a part of the chip connection assembly moves relative to the housing as a movable member between a first position and a second position;
before the developing cartridge is mounted, the movable member is in the first position, and in this case, an electrical connection between the electrical contact and the device is broken, and then a communication connection is not established between the electrical contact and the device; and
as the developing cartridge is mounted, the movable member moves from the first position to the second position, and in the second position, the movable member enables the electrical connection between the electrical contact and the device to be implemented, to establish the communication connection between the electrical contact and the device.

2. The developing cartridge according to claim 1, wherein a midline passes through a midpoint in a front-back direction of the developing cartridge and is parallel to an up-down direction, the developing member is located in front of the housing, the driving force receiving member and the electrical contact are respectively located on two sides of the midline, and the electrical contact is closer to a rear side of the developing cartridge than the driving force receiving member.

3. The developing cartridge according to claim 2, wherein the developing cartridge further comprises a stirring member located in the housing, wherein the stirring member receives a driving force of the driving force receiving member to move, and in a front-back direction, the electrical contact is located on a rear side of a rotation axis of the stirring member.

4. The developing cartridge according to claim 1, wherein when the developing cartridge is taken out from the device, the movable member returns from the second position to the first position, the electrical connection between the electrical contact and the device is broken, and then the communication connection is not established between the electrical contact and the device.

5. The developing cartridge according to claim 1, wherein the housing comprises a bottom housing and a top cover, wherein the bottom housing and the top cover are combined in an up-down direction, and a cavity for accommodating toner is formed between the bottom housing and the top cover; and
the developing cartridge further comprises a protective plate and a plurality of ribs protruding from the bottom housing, and the protective plate is combined with the bottom housing, to prevent the plurality of ribs from being broken.

6. The developing cartridge according to claim 1, wherein before the developing cartridge is mounted, the movable member is electrically connected to the electrical contact, and as the developing cartridge is mounted into the device, the movable member presses against the electrical contact of the device.

7. The developing cartridge according to claim 1, wherein the developing cartridge further comprises an end cover, wherein the end cover is disposed on a same side as the driving force receiving member and is combined with the housing, the driving force receiving member is exposed through a through hole in the end cover, and the chip is fixedly mounted on the housing or the end cover; and
the chip connection assembly further comprises a conductor movable along with the movable member, the conductor does not contact the electrical contact in the first position, and the conductor contacts the electrical contact in the second position.

8. The developing cartridge according to claim 7, wherein the movable member is mounted in a manner of rotating around a rotation axis, and the rotation axis is parallel to a rotation axis of the driving force receiving member; and in the first position, the conductor and the electrical contact are separated from each other to break an electrical connection, when the developing cartridge is mounted, the movable member receives an external force to move from the first position to the second position, and in the second position, the conductor and the electrical contact are in contact with each other to implement the electrical connection.

9. The developing cartridge according to claim 7, wherein the chip connection assembly further comprises a movable rod, wherein the movable rod is combined with the movable member, the movable rod moves in an up-down direction of the developing cartridge, and the movable member moves between the first position and the second position with the movable rod; and in the first position, the conductor and the electrical contact are separated from each other to break an electrical connection, when the developing cartridge is mounted, the movable rod receives an external force to enable the movable member to move from the first position to the second position, and in the second position, the conductor and the electrical contact are in contact with each other to implement the electrical connection.

10. The developing cartridge according to claim 7, wherein the movable member slides on a plane, wherein the plane intersects with the up-down direction.

11. The developing cartridge according to claim 1, wherein a power terminal configured to be electrically connected to the electrical contact is disposed in the device, and the developing cartridge further comprises an end cover, wherein the end cover is disposed on a same side as the driving force receiving member and is combined with the housing, and the driving force receiving member is exposed through a through hole in the end cover;
the chip connection assembly further comprises a mounting plate and a conductor, wherein the mounting plate and the conductor are disposed on the housing or the end cover, and at least the electrical contact of the chip is mounted in the movable member;
in the first position, the conductor and the electrical contact are separated from each other to break an electrical connection;
as the developing cartridge is mounted, the movable member receives an external force to move from the first position to the second position, and at least the electrical contact of the chip moves together with the movable member; and
when the developing cartridge reaches a predetermined mounting position, the conductor contacts the power terminal, and the electrical contact contacts the conductor.

12. The developing cartridge according to claim 11, wherein the chip connection assembly further comprises a pressing member, wherein the pressing member presses against the conductor.

13. The developing cartridge according to claim 11, wherein the chip connection assembly further comprises a supporting member disposed adjacent to at least one of the conductor and the chip, and the supporting member is configured to support at least one of the chip and the conductor in a direction in which the chip and the conductor approach each other.

14. The developing cartridge according to claim 11, wherein the chip connection assembly further comprises an acting force transmitting mechanism, wherein the acting force transmitting mechanism is combined with the movable member, and the acting force transmitting mechanism is a stroke amplifying mechanism.

15. The developing cartridge according to claim 14, wherein the acting force transmitting mechanism comprises a transmitting member, a driving rod and a driven rod, wherein the driving rod and the driven rod are combined with the transmitting member, the transmitting member is disposed as a dual gear having a pinion portion and a gearwheel portion, the driving rod is combined with the pinion portion and is configured to receive a driving force from outside, and the driven rod is combined with the gearwheel portion and the movable member.

16. The developing cartridge according to claim 14, wherein the acting force transmitting mechanism is a rotating rod, wherein the rotating rod rotates around a rotating shaft, and the rotating rod is a hard lever.

17. The developing cartridge according to claim 1, wherein the developing cartridge further comprises a first driving member, a stirring member and a second driving member wherein the first driving member is combined with the driving force receiving member, the stirring member and the second driving member are located in the housing, and the second driving member is directly combined with the first driving member to drive the stirring member to move.

18. The developing cartridge according to claim 17, wherein the developing cartridge further comprises an elastic member located between the stirring member and the second driving member, and the stirring member reciprocates in the housing in a direction perpendicular to a rotation axis of the developing member under a joint action of the elastic member and the second driving member.

19. The developing cartridge according to claim 17, wherein the second driving member comprises a middle rod, a first combining portion on a side of the middle rod, and a force applying portion between the middle rod and the first combining portion, wherein the second driving member is combined with the first driving member through the first combining portion, and an avoidance portion configured to allow a part of the stirring member to enter is disposed on the force applying portion.

20. The developing cartridge according to claim 17, wherein the developing cartridge further comprises a buffer member disposed between the stirring member and the housing, and when the stirring member moves forward, the stirring member presses against the buffer member.
